(19) United States
(12) Patent Application Publication
(10) Pub. No.: US 2019/0268155 A1
(43) Pub. Date: Aug. 29, 2019

(54) Method for Ensuring Terminal Security and Device

(71) Applicant: Huawei Technologies Co., Ltd., Shenzhen (CN)

(72) Inventor: Peizhen GUO, Nanjing (CN)

(73) Assignee: Huawei Technologies Co., Ltd., Shenzhen (CN)

(21) Appl. No.: 16/308,287

(22) PCT Filed: Dec. 4, 2017
(86) PCT No.: PCT/CN2017/114504

§ 371 Date: Dec. 7, 2018

(30) Foreign Application Priority Data
Dec. 2, 2016 (CN) 201611097112.9
Mar. 31, 2017 (CN) PCT/CN2017/079082

(51) Int. Cl. H04L 9/32; H04L 29/06; H04L 9/08

(52) U.S. Cl. CPC H04L 9/3213; H04L 63/0876; H04L 63/083; H04L 9/0872; H04L 63/20

(57) ABSTRACT

In a method for ensuring a terminal security, a secure memory area is set on a baseband chip of a terminal, the secure memory area storing data to ensure the terminal security, and the baseband chip performs the following steps of obtaining authentication data from the secure memory area, sending a status query request to a security management server, where the status query request carries the authentication data, and the authentication data is used by the security management server to determine an identity of the terminal, receiving a status response from the security management server based on the identity of the terminal, and activating, based on the status response, a preset protection policy when the terminal is in a missing claiming state.

### TECHNICAL FIELD

The present invention relates to the field of terminal security, and in particular, to a method for ensuring terminal security and a device.

### BACKGROUND

With popularization of intelligent terminals, a user obtains convenient, quick, and flexible user experience, and is also confronted with a security risk of personal data leakage caused when a terminal is lost. When the terminal is lost, the user wants to locate the lost terminal in a remote manner to find the lost terminal, or when the terminal cannot be found, the user wants to remotely erase personal data to prevent personal data leakage. Currently, each terminal manufacturer integrates an antitheft module into a cloud service of the manufacturer and the terminal, and binds an antitheft function of the terminal to an account system of the corresponding manufacturer. The user can enable the antitheft function of the terminal after logging in to the cloud service by using a cloud service account. When the terminal is lost and is connected to a network (WiFi or a data network), the user may log in to a portal system of the terminal manufacturer, and remotely initiate a positioning instruction or a data erase instruction to the lost terminal. After receiving the remote instruction, the terminal executes the instruction of positioning or erasing personal data, and finally reports an execution result to a server.

An existing antitheft procedure of the terminal mainly includes two procedures: activation and remote control. The activation procedure of the antitheft function is shown in FIG. 1, and includes the following steps: S101. After a user enters an account and a password on a terminal for login, an antitheft client (PhoneFinder Client, PF Client) of the terminal sends the account and the password to an authentication server (User profile Server, Up Server). S102. The authentication server Up Server verifies the account and the password, and sends a first authentication token serviceToken to the antitheft client PF Client after the verification succeeds. S103. The antitheft client PF Client sends an international mobile equipment identity (International Mobile Equipment Identity, IMEI) of the terminal and a name of an Android package (Android Package, APK) of the antitheft client PF Client to a message push server Push Server. S104. The message push server Push Server generates a message push token pushToken based on the IMEI and the name of the APK, and sends the message push token pushToken to the antitheft client PF Client. S105. The antitheft client PF Client sends an activation request to a security management server (PhoneFinderServer, PFServer), where the activation request carries the message push token pushToken and the first authentication token serviceToken. S106. The security management server PF Server sends the first authentication token serviceToken to the authentication server Up Server, to determine validity of the activation request. S107. After authenticating the first authentication token serviceToken, the authentication server Up Server sends an “authentication succeeds” response to the security management server PF Server. S108. After completing an activation procedure on a server side, the security management server PF Server sends an “activation succeeds” response to the antitheft client PF Client. According to the activation procedure in FIG. 1, the antitheft function of the terminal is activated after the account and password are verified. When the terminal is lost, the user may perform remote control on the terminal, and the remote control procedure of the antitheft function is shown in FIG. 2, and includes the following steps: S201. The user enters an account and a password in a portal system, and the portal system Portal sends the account and the password to the authentication server Up Server. S202. The authentication server Up Server verifies the account and the password, and sends a second authentication token upToken to the portal system Portal after the verification succeeds. S203. The portal system Portal obtains a remote control instruction of the user, and sends, to the security management server PF Server, a remote control request that carries the second authentication token upToken and the remote control instruction. S204. The security management server PF Server sends the second authentication token upToken to the authentication server Up Server, to determine validity of the remote control request. S205. After authenticating the second authentication token upToken, the authentication server Up Server sends an “authentication succeeds” response to the security management server PF Server. S206. The security management server PF Server sends a message push token pushToken and the remote control instruction to the message push server Push Server. S207. The message push server Push Server keeps a socket connection to the antitheft client PF Client, and sends the remote control instruction to the antitheft client PF Client. S208. The antitheft client PF Client executes an operation corresponding to the remote control instruction. S209. The antitheft client PF Client sends, to the security management server PF Server, an execution result of executing the operation corresponding to the remote control instruction. S210. The security management server PF Server sends the execution result to the portal system Portal. S211. The portal system Portal displays the execution result to the user. By remotely controlling the terminal, the user may enable the terminal to execute operations such as positioning and erasing data, so as to find the terminal or prevent personal data leakage.

In the prior art, the antitheft function is implemented in an operating system of an application processor, and is bound to a cloud service account system of a manufacturer. When the operating system (which is an operating system such as an Android system or an iOS system on the application processor) on the terminal is removed or replaced, the antitheft function of the terminal fails, remote control over the terminal cannot be implemented, and terminal security is relatively low.

### SUMMARY

Embodiments of the present invention provide a method for ensuring terminal security and a device, to resolve a problem that an antitheft function of a terminal fails when an operating system on an application processor of the terminal is removed or replaced, and to improve terminal security.

According to a first aspect of the embodiments of the present invention, a method for ensuring terminal security is provided, where a secure memory area is set on a baseband chip of a terminal, the secure memory area is used to store data that ensures terminal security, and the baseband chip performs the following steps:

obtaining authentication data from the secure memory area;

sending a status query request to a security management server, where the status query request carries the authentication data, and the authentication data is used by the security management server to determine an identity of the terminal;

receiving a status response that is sent by the security management server based on the identity of the terminal; and

activating a preset protection policy when determining, based on the status response, that the terminal is in a missing claiming state.

In a first possible implementation of the first aspect, the authentication data may be first authentication token data, the first authentication token data is sent by an authentication server, and before the obtaining authentication data from the secure memory area, the method further includes: receiving first authentication token data sent by an application processor of the terminal, and saving the first authentication token data to the secure memory area.

Specifically, the authentication server may be an account authentication server, and identity information of the user may be account information and password information entered by the user on the terminal.

In a second possible implementation of the first aspect, the authentication data may be first encrypted data, and before the obtaining authentication data from the secure memory area, the method further includes: encrypting terminal identifier data by using a preset key to obtain the first encrypted data, and saving the first encrypted data to the secure memory area. Specifically, the terminal identifier data may be unique terminal identifier data that is used to identify the identity of the terminal, for example, an IMEI, an international mobile subscriber identity (International Mobile Subscriber Identification Number, IMSI), and a mobile equipment identifier (Mobile Equipment Identifier, MEID).

In a third possible implementation of the first aspect, the preset protection policy may include: sending a control instruction query request to the security management server, where the control instruction query request carries the authentication data; receiving a remote control instruction sent by the security management server; and executing a target operation corresponding to the remote control instruction, and returning, to the security management server, an execution result obtained after the target operation is executed. Specifically, the target operation corresponding to the remote control instruction may be operations such as positioning, erasing data, disabling a multimedia application function of the terminal, sound alerting, and SMS message alerting.

In a fourth possible implementation of the first aspect, the preset protection policy may include: obtaining current location information of the terminal, encrypting the current location information of the terminal to obtain second encrypted data, and sending the second encrypted data to the security management server.

In a fifth possible implementation of the first aspect, the preset protection policy may include: prompting, in an alerting manner, that the terminal is in the missing claiming state. Specifically, for example, the security protection client displays a pop-up window “the terminal is currently in the missing claiming state” in an interface of the terminal.

According to a second aspect of the embodiments of the present invention, another method for ensuring terminal security is provided, where a secure memory area is set on a baseband chip of a terminal, the secure memory area is used to store data that ensures terminal security, and the terminal performs the following steps:

obtaining authentication data from the secure memory area;

sending a status query request to a security management server, where the status query request carries the authentication data, and the authentication data is used by the security management server to determine an identity of the terminal;

receiving a status response that is sent by the security management server based on the identity of the terminal; and

activating a preset protection policy when determining, based on the status response, that the terminal is in a missing claiming state.

In a first possible implementation of the second aspect, the authentication data includes first authentication token data, and before the obtaining authentication data from the secure memory area, the method further includes: receiving first authentication token data sent by an authentication server, where the first authentication token data is sent to the terminal after identity verification information of a user of the terminal that is sent by the terminal is verified by the authentication server; and saving the first authentication token data to the secure memory area.

In a second possible implementation of the second aspect, the authentication data includes first encrypted data, and before the obtaining authentication data from the secure memory area, the method further includes: requesting the baseband chip to encrypt terminal identifier data by using a preset key, to obtain the first encrypted data.

In a third possible implementation of the second aspect, the preset protection policy includes: sending a control instruction query request to the security management server, where the control instruction query request carries the authentication data; receiving a remote control instruction sent by the security management server; and executing a target operation corresponding to the remote control instruction, and returning, to the security management server, an execution result obtained after the target operation is executed.

In a fourth possible implementation of the second aspect, the preset protection policy includes: obtaining current location information of the terminal, requesting the baseband chip to encrypt the location information to obtain second encrypted data, and sending the second encrypted data to the security management server.

In a fifth possible implementation of the second aspect, the preset protection policy includes: prompting, in an alerting manner, that the terminal is in the missing claiming state.

In a sixth possible implementation of the second aspect, the obtaining authentication data from the secure memory area includes: obtaining the authentication data from the secure memory area by using a security protection client that runs on the baseband chip.

According to a third aspect of the embodiments of the present invention, still another method for ensuring terminal security is provided, including:

receiving a status query request sent by a terminal, where the status query request carries authentication data, and the authentication data is stored in a secure memory area of a baseband chip of the terminal;

determining an identity of the terminal based on the authentication data; and

sending a status response to the terminal based on the identity of the terminal, where the status response is used by the terminal to determine a status of the terminal, and the terminal activates a preset protection policy when determining that the terminal is in a missing claiming state.

In a first possible implementation of the third aspect, the method further includes: receiving a missing claiming request of a user, where the missing claiming request carries terminal identifier data; determining, based on the terminal identifier data, a terminal corresponding to the missing claiming request; and recording a status of the terminal corresponding to the missing claiming request as the missing claiming state. Specifically, when it is determined that the missing claiming request is a valid request, the status of the terminal corresponding to the missing claiming request is recorded as the missing claiming state. For example, the missing claiming request may carry a first authentication token sent by an authentication server. For another example, a server that sends the missing claiming request is a server in a whitelist, and a missing claiming request sent by the server in the whitelist is considered as a valid request by default.

In a second possible implementation of the third aspect, after the sending a status response to the terminal, the method may further include: receiving a control instruction query request sent by the terminal, where the control instruction query request carries the authentication data; when detecting that there is a remote control instruction corresponding to the terminal, sending the remote control instruction to the terminal; and receiving an execution result that is returned by the terminal and that is obtained after the terminal executes a target operation corresponding to the remote control instruction.

With reference to the second possible implementation of the third aspect, in a third possible implementation of the third aspect, before the sending the remote control instruction to the terminal, the method may further include: receiving a remote control request of a user, where the remote control request carries terminal identifier data of the terminal and the remote control instruction corresponding to the terminal; and caching the terminal identifier data and the remote control instruction.

In a fourth possible implementation of the third aspect, after the sending a status response to the terminal, the method may further include: receiving second encrypted data sent by the terminal, and decrypting the second encrypted data, to obtain current location information of the terminal.

According to a fourth aspect of the embodiments of the present invention, a baseband chip is provided, where a secure memory area is set on the baseband chip, the secure memory area is used to store data that ensures terminal security, and the baseband chip includes:

a processing unit, configured to obtain authentication data from the secure memory area;

a sending unit, configured to send a status query request to a security management server, where the status query request carries the authentication data, and the authentication data is used by the security management server to determine an identity of the terminal; and

a receiving unit, configured to receive a status response that is sent by the security management server based on the identity of the terminal, where

the processing unit is further configured to activate a preset protection policy when determining, based on the status response, that the terminal is in a missing claiming state.

In a possible design, a structure of the baseband chip includes a processor and a communications interface, and the processor is configured to perform the method for ensuring terminal security according to the first aspect of the embodiments of the present invention. Optionally, the structure of the baseband chip may further include a memory, the memory includes a secure memory area, the secure memory area is used to store application program code and authentication data that support the baseband chip in performing the foregoing method, and the processor is configured to execute an application program stored in the memory.

According to a fifth aspect of the embodiments of the present invention, a terminal is provided, where a secure memory area is set on a baseband chip of the terminal, the secure memory area is used to store data that ensures terminal security, and the terminal includes:

a processing unit, configured to obtain authentication data from the secure memory area;

a sending unit, configured to send a status query request to a security management server, where the status query request carries the authentication data, and the authentication data is used by the security management server to determine an identity of the terminal; and

a receiving unit, configured to receive a status response that is sent by the security management server based on the identity of the terminal, where

the processing unit is further configured to activate a preset protection policy when determining, based on the status response, that the terminal is in a missing claiming state.

In a possible design, a structure of the terminal includes a processor and a communications interface, and the processor is configured to perform the method for ensuring terminal security according to the second aspect of the embodiments of the present invention. Optionally, the structure of the terminal may further include a memory, the memory includes a secure memory area, the secure memory area is used to store application program code and authentication data that support the terminal in performing the foregoing method, and the processor is configured to execute an application program stored in the memory.

According to a sixth aspect of the embodiments of the present invention, a security management server is provided, including:

a receiving unit, configured to receive a status query request sent by a terminal, where the status query request carries authentication data, and the authentication data is stored in a secure memory area of a baseband chip of the terminal;

a processing unit, configured to determine an identity of the terminal based on the authentication data; and

a sending unit, configured to send a status response to the terminal, where the status response is used by the terminal to determine a status of the terminal, and the terminal activates a preset protection policy when determining that the terminal is in a missing claiming state.

In a possible design, a structure of the security management server includes a processor and a communications interface, and the processor is configured to perform the method for ensuring terminal security according to the third aspect of the embodiments of the present invention. Optionally, the structure of the security management server may further include a memory, the memory is configured to store application program code that supports the security management server in performing the foregoing method, and the processor is configured to execute an application program stored in the memory.

According to a seventh aspect of the embodiments of the present invention, a computer storage medium is provided, and the computer storage medium is configured to store a computer software instruction used by the foregoing baseband chip, and includes a program designed for the foregoing baseband chip to execute the first aspect.

According to an eighth aspect of the embodiments of the present invention, a computer storage medium is provided, and the computer storage medium is configured to store a computer software instruction used by the foregoing terminal, and includes a program designed for the foregoing terminal to execute the second aspect.

According to a ninth aspect of the embodiments of the present invention, a computer storage medium is provided, and the computer storage medium is configured to store a computer software instruction used by the foregoing security management server, and includes a program designed for the foregoing security management server to execute the third aspect.

In the embodiments of the present invention, the secure memory area is set on the baseband chip of the terminal, and may be used to store the data that ensures terminal security. When determining that the terminal is in the missing claiming state, the terminal activates the preset protection policy. Data is stored in the secure memory area. Therefore, methods such as ROM flashing cannot invalidate the protection policy of the terminal, an antitheft function of the terminal can be normally implemented, and terminal security can be improved.

### BRIEF DESCRIPTION OF DRAWINGS

To describe the technical solutions in the embodiments of the present invention or in the background more clearly, the following briefly describes the accompanying drawings required for describing the embodiments of the present invention or the background.

FIG. 1 is a schematic diagram of an activation procedure of an antitheft function of a terminal according to an existing technical solution;

FIG. 2 is a schematic diagram of a remote control procedure of an antitheft function of a terminal according to an existing technical solution;

FIG. 3A is a structural block diagram of an implementation of a terminal according to an embodiment of the present invention;

FIG. 3B is a structural block diagram of an implementation of a terminal according to an embodiment of the present invention;

FIG. 3C-1 and FIG. 3C-2 are a structural block diagram of an implementation of a terminal according to an embodiment of the present invention;

FIG. 3D is a structural block diagram of an implementation of a terminal according to an embodiment of the present invention;

FIG. 3E-1 and FIG. 3E-2 are a structural block diagram of an implementation of a terminal according to an embodiment of the present invention;

FIG. 4 is a schematic flowchart of a method for ensuring terminal security according to an embodiment of the present invention;

FIG. 5 is a schematic diagram of displaying a missing claiming result to a user by a portal system Portal according to an embodiment of the present invention;

FIG. 6A and FIG. 6B are a schematic flowchart of a method for activating a preset protection policy according to an embodiment of the present invention;

FIG. 7 is a schematic diagram of a portal system page used by a portal system to obtain an account and a password that are entered by a user according to an embodiment of the present invention;

FIG. 8A and FIG. 8B are a schematic flowchart of a method for executing a preset protection policy according to an embodiment of the present invention;

FIG. 9 is a schematic flowchart of another method for activating a preset protection policy according to an embodiment of the present invention;

FIG. 10 is a schematic flowchart of another method for executing a preset protection policy according to an embodiment of the present invention;

FIG. 11A is a schematic diagram of a page after a user successfully logs in to a portal system according to an embodiment of the present invention;

FIG. 11B is a schematic diagram of a remote management page of a portal system according to an embodiment of the present invention;

FIG. 11C is a schematic diagram of a page used by a portal system to display a remote control result to a user according to an embodiment of the present invention;

FIG. 11D is a schematic diagram of a page used by a portal system to display a geographic location movement track of a mobile phone to a user according to an embodiment of the present invention;

FIG. 12 is a schematic structural diagram of a baseband chip according to an embodiment of the present invention;

FIG. 13 is a schematic structural diagram of a terminal and a security management server according to an embodiment of the present invention;

FIG. 14 is a schematic structural diagram of another baseband chip according to an embodiment of the present invention;

FIG. 15 is a schematic structural diagram of another security management server according to an embodiment of the present invention;

FIG. 16 shows an interface for sending a remote control instruction according to an embodiment of the present invention; and

FIG. 17 is a running block diagram of a mobile phone antitheft system according to an embodiment of the present invention.

### DESCRIPTION OF EMBODIMENTS

The following describes the technical solutions in the embodiments of the present invention with reference to the accompanying drawings in the embodiments of the present invention.

An implementation of a terminal device in the embodiments of the present invention is described first. The terminal device has at least two processor units. One processor is configured to run advanced mobile subscriber software (Advanced Mobile Subscriber Software, AMSS). The AMSS is a basic communications operating system, and is configured to start a modem (Modem) of the terminal and provide a basic communication function for the terminal. At least one processor is a multimedia application processor (Multimedia Application Processor, MAP), and is configured to run an application operating system (such as an Android system or an iOS system). During specific implementation, the at least two processors may be integrated into one hardware chip (for example, integrated into a baseband chip), or may be disposed on two different hardware chips (for example, a baseband chip and an application processor chip). The two different hardware chips (the baseband chip and the application processor chip) may be integrated into a same chip, for example, integrated into an SoC (System on Chip) chip. The terminal device further includes a secure memory area. The secure memory area is isolated from another memory area of the terminal, and rejects access of an insecure object or application program. In an embodiment, the secure memory area may be isolated from the another memory area by using a TrustZone technology.

In the embodiments of the present invention, data that ensures terminal security may be stored in a secure area. Specifically, the data that ensures terminal security may be authentication data, account data (for example, account information and password information, namely, a cloud service account, that are used to ensure terminal security and that are registered by a user by using a terminal) of the terminal, an application program corresponding to a security protection client that ensures terminal security and that runs on AMSS, or the like.

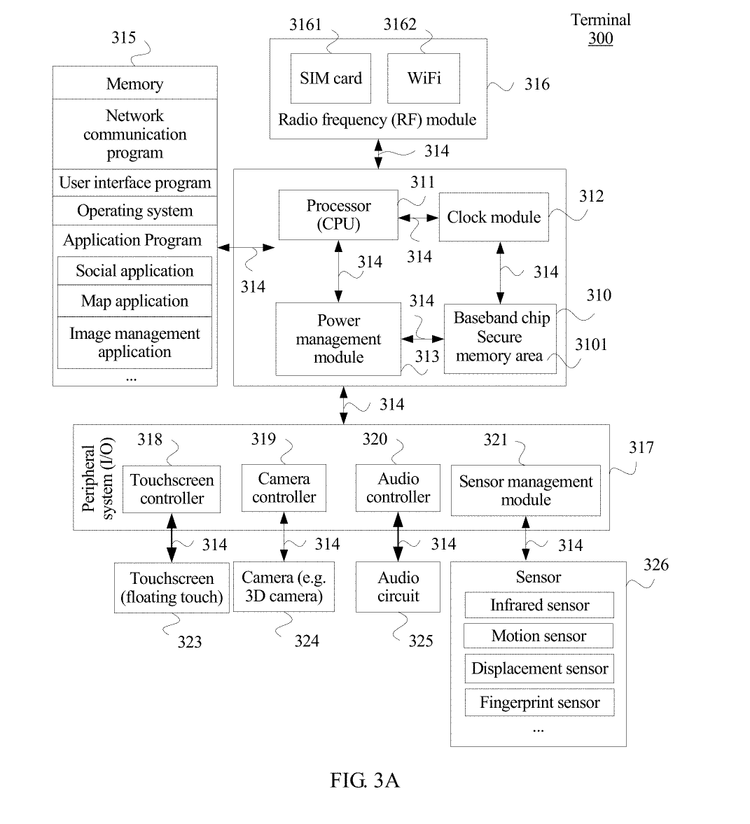

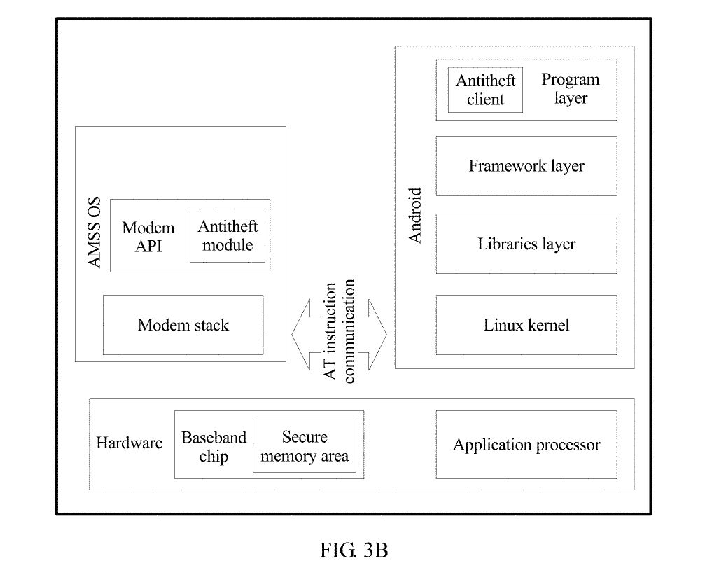

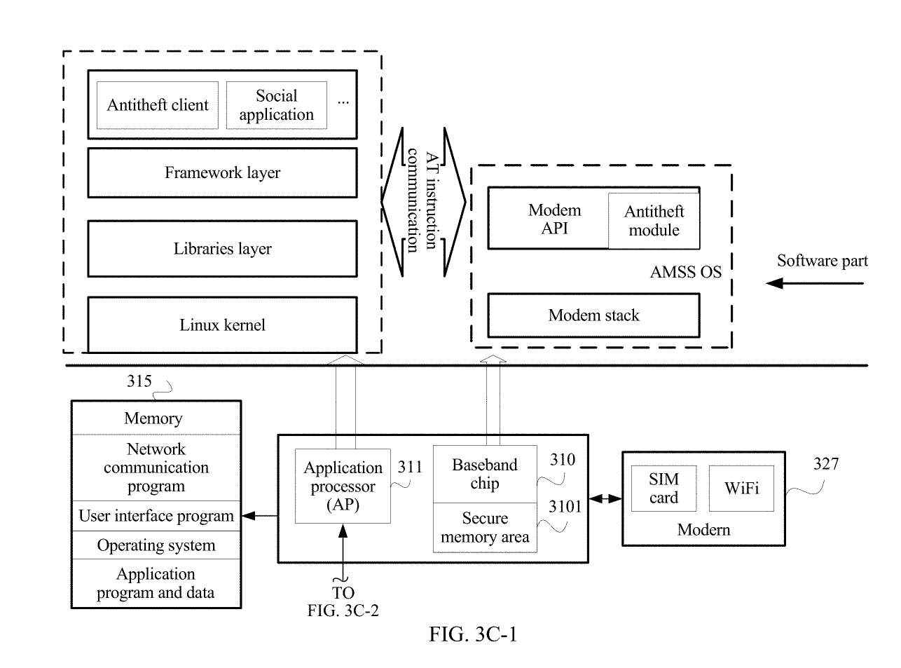

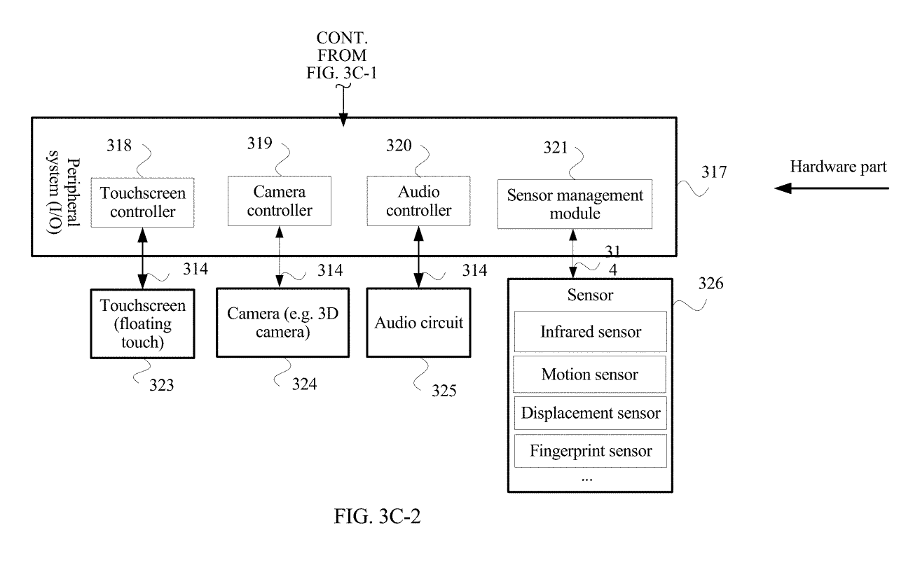

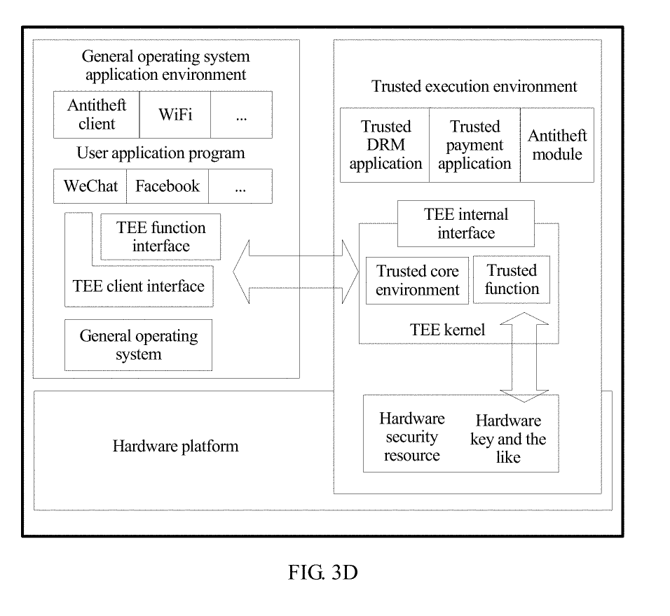

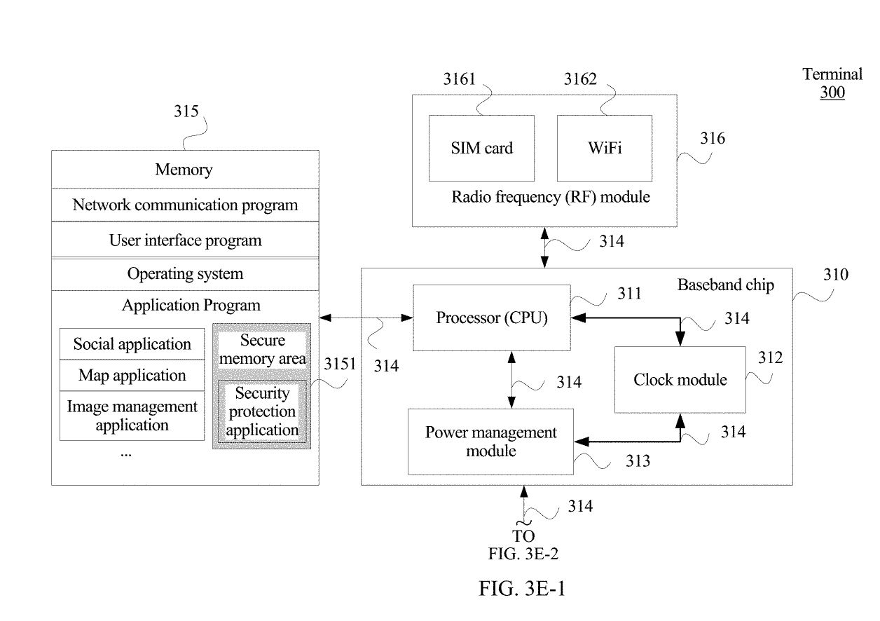

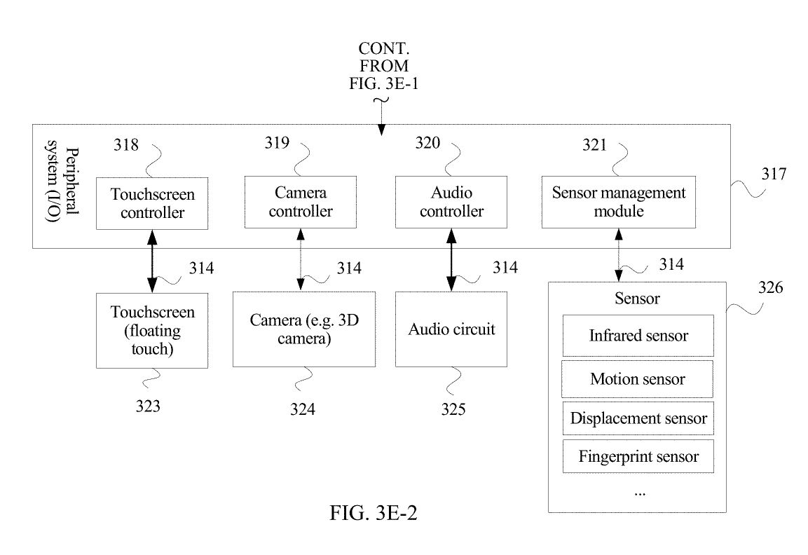

FIG. 3A is a structural block diagram of an implementation of a terminal device 300. As shown in FIG. 3A, the terminal 300 may include a baseband chip 310, a memory 315 (one or more computer readable storage media), a radio frequency (RF) module 316, and a peripheral system 317. These components may communicate with each other by using one or more communications buses 314.

The peripheral system 317 is mainly configured to implement an interaction function between the terminal 300 and a user/external environment, and mainly includes an input/output apparatus of the terminal 300. During specific implementation, the peripheral system 317 may include a touchscreen controller 318, a camera controller 319, an audio controller 320, and a sensor management module 321. The controllers may be coupled to respective corresponding peripheral devices (for example, a touchscreen 323, a camera 324, an audio circuit 325, and a sensor 326). In some embodiments, the touchscreen 323 may be a touchscreen on which a self-capacitive floating touch panel is configured, or may be a touchscreen on which an infrared floating touch panel is configured. In some embodiments, the camera 324 may be a 3D camera. It should be noted that the peripheral system 317 may further include another I/O peripheral.

A processor 311 may be an application processor (Application processor), and is configured to run an application program and process user data. A clock module 312 is mainly configured to generate, for the processor 311, a clock required for data transmission and timing control. A power management module 313 is mainly configured to provide stable and high-precision voltage for the processor 311, the radio frequency module 316, and the peripheral system. The baseband chip 310 may include a baseband processor, a channel encoder, a digital signal processor, a modem, and an interface module. A secure memory area 3101 integrated on the baseband chip 310 is used to store data that ensures terminal security. In some embodiments, the secure memory area 3101 may also store a security protection application program that ensures terminal security.

The radio frequency (RF) module 316 is configured to receive and send a radio frequency signal, and mainly integrates a receiver and a transmitter of the terminal 300. The radio frequency (RF) module 316 communicates with a communications network and another communications device by using a radio frequency signal. During specific implementation, the radio frequency (RF) module 316 may include but is not limited to an antenna system, an RF transceiver, one or more amplifiers, a tuner, one or more oscillators, a digital signal processor, a CODEC chip, a SIM card, a storage medium, and the like. In some embodiments, the radio frequency (RF) module 316 may be implemented on a separate chip. During specific implementation, the radio frequency (RF) module 316 receives and sends a radio frequency signal under the control of the baseband chip.

The memory 315 is coupled to the processor 311, and is configured to store various software programs and/or a plurality of sets of instructions. During specific implementation, the memory 315 may include a high-speed random access memory, and may further include a nonvolatile memory, for example, one or more magnetic disk storage devices, a flash memory, or another nonvolatile solid-state storage device. The memory 315 may store an operating system (referred to as a system for short below), for example, an embedded operating system such as an Android system, an iOS system, a Windows system, or a Linux system. Specifically, the operating system may include an application operating system (for example, the Android system or the iOS system in which various multimedia application programs run) and a basic communications operating system (for example, an AMSS OS). The memory 315 may further store a network communication program. The network communication program may be used to communicate with one or more adjuncts, one or more terminal devices, and one or more network devices. The memory 315 may further store a user interface program. The user interface program may vividly display content of an application program by using a graphical operation interface, and receive, by using an input control such as a menu, a dialog box, and a key, a control operation performed on the application program by a user.

The memory 315 may further store one or more application programs. As shown in FIG. 3A, the application programs may include a social application program (for example, Facebook), an image management application program (for example, Album), a map application program (for example, Google map), a browser (for example, Safari or Google Chrome), and the like.

In this embodiment of the present invention, the data that ensures terminal security is stored in the secure memory area of the baseband chip, and independent invoking and independent operation are performed on the data on the baseband chip. Even when the application operating system or account information is cleared, the terminal can still activate a preset protection policy to ensure terminal security.

FIG. 3B is a structural block diagram of an implementation of a terminal device 300. A hardware layer of the terminal device includes a baseband chip that is used in a basic communication operating system (for example, an AMSS OS in FIG. 3B), and an application processor that is configured to run an embedded operating system (for example, an Android system in FIG. 3B). An independent secure memory area is set on the baseband chip such as a HiSilicon chip for a mobile phone antitheft module. The AMSS is an operating system running on the baseband chip, and is used to process a communications protocol, radio frequency, GPIO, and the like. A modem stack may be a protocol stack of a modem, and is used to implement communication with the hardware baseband chip. A modem API may be an interface layer of the modem, is encapsulated with a network processing capability and a signal processing capability of the modem, and is encapsulated with, for the Android operating system, a call capability, an Internet access capability, and an SMS message capability that can be invoked. The antitheft module may run on the AMSS system, and may implement cloud interaction through socket (also referred to as “socket”) communication. A Linux core layer may be a lightweight linux operating system kernel customized for the Android system, and provide services such as security, memory management, process management, a network protocol stack, and a driver model. A system runtime library layer (Libraries) may include a program library and an Android runtime library. The Android runtime library includes some C/C++ libraries, and the libraries can be used by different components in the Android system. The C/C++ libraries provide services for a developer by using an Android application program framework, and are encapsulated with a capability of the linux kernel for being invoked by an uploaded framework. An application program framework layer (Framework) is a Java language layer, and further encapsulates the libraries layer into an application programming interface API that can be invoked by Java code. An application program layer may provide a series of core application programs, for example, an email, an SMS message, a calendar, a map, a browser, and contact management. The developer may use Java language to design and write an application program belonging to the developer, or may use Java language to run an APK (Android Package). An antitheft client is located at the application layer, and is configured to interact with a user.

In a possible embodiment, the antitheft client accepts information entered by the user, for example, the information may be an account or a password, and enters the antitheft module by using an AT instruction. The antitheft module transmits, to the secure memory area of the baseband chip, the information entered by the user. In a possible embodiment, when an application operating system or account information is cleared, for example, when a system of the terminal device is reinstalled, information stored by the user in the secure memory area of the baseband chip is not lost.

In this embodiment of the present invention, data that ensures terminal security is stored in the secure memory area of the baseband chip, and independent invoking and independent operation are performed on the data on the baseband chip. Even when the application operating system or the account information is cleared, the terminal can still activate a preset protection policy to ensure terminal security.

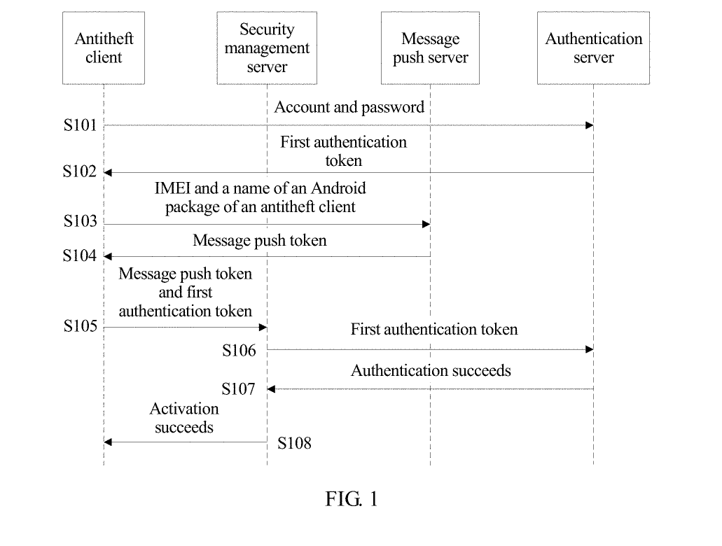

FIG. 3C-1 and FIG. 3C-2 are a structural block diagram of an implementation of a terminal device 300. The terminal device 300 includes a software part and a hardware part. An antitheft client is located at an application layer of a system, and provides an interface for interacting with a user. A modem API may be an interface layer of a modem, is encapsulated with a network processing capability and a signal processing capability of the modem, and is encapsulated with, for an Android operating system, a call capability, an Internet access capability, and an SMS message capability that can be invoked. An antitheft module may run on an AMSS system, and may implement cloud interaction through socket (also referred to as “socket”) communication. An application processor (Application processor) runs an application program and processes user data. An independent secure memory area is set on a baseband chip for the mobile phone antitheft module.

In this embodiment of the present invention, data that ensures terminal security is stored in the secure memory area of the baseband chip, and independent invoking and independent operation are performed on the data on the baseband chip. Even when an application operating system or account information is cleared, the terminal can still activate a preset protection policy to ensure terminal security.

FIG. 3D is a structural block diagram of an implementation of a terminal device 300. A trusted execution environment (TEE, Trusted Execution Environment) is an independent running environment that runs outside a general operating system (for example, an Android system). The TEE provides a security service for the general operating system and is isolated from the general operating system. The general operating system and an application program in the general operating system cannot access hardware and software security resources of the TEE. The TEE provides a secure and executable environment for secure software referred to as a trusted application program. The TEE also enhances protection of confidentiality, integrity, and access rights of data and resources in the trusted application program. To ensure credibility of the TEE, the TEE performs authentication in a security boot process and is separated from the operating system. Trusted applications are independent in the TEE. The trusted application program cannot access a security resource of another trusted application program without authorization. Trusted application programs may be provided by different application service providers. In the TEE, access by a trusted application to a security resource and a service is controlled by using a TEE internal interface (TEE internal API). The resource and the service include key entry and management, encryption, secure storage, a secure clock, a trusted user interface (UI), a trusted keyboard, and the like.

As shown in FIG. 3D, the terminal device includes a general operating system application environment that may be a general operating system (for example, the Android system), a client application program, or the like; and the trusted execution environment (TEE) that is the independent running environment that runs outside the general operating system. The TEE provides the security service for the general operating system and is isolated from the general operating system. In the general operating system application environment, an antitheft client is provided for interacting with a user. For example, the antitheft client may be a third-party application program or a system interface. In the trusted execution environment (TEE), an antitheft module is provided, for example, the antitheft module may be a trusted antitheft application. A hardware security resource stores security information of the user, for example, the security information may be various security data such as an account and a password. Access by a trusted application to a security resource and a service may be controlled by using a TEE internal API (TEE internal API). In some embodiments, the security information may also be stored in the antitheft module.

In this embodiment of the present invention, data that ensures terminal security is stored in the hardware security resource, an operating system and an application program in the operating system cannot access hardware and software security resources of the TEE, and trusted applications are independent in the TEE.

The trusted application program cannot access a security resource of another trusted application program without authorization. Even when an application operating system or account information is cleared, the terminal can still activate a preset protection policy to ensure terminal security.

As shown in FIG. 3E-1 and FIG. 3E-2, in some embodiments, a memory 315 may also include a secure memory area 3151 to store data that ensures terminal security, for example, store a security protection application program that ensures terminal security. Specifically, a specific form of the security protection application program may be a security protection client running on AMSS.

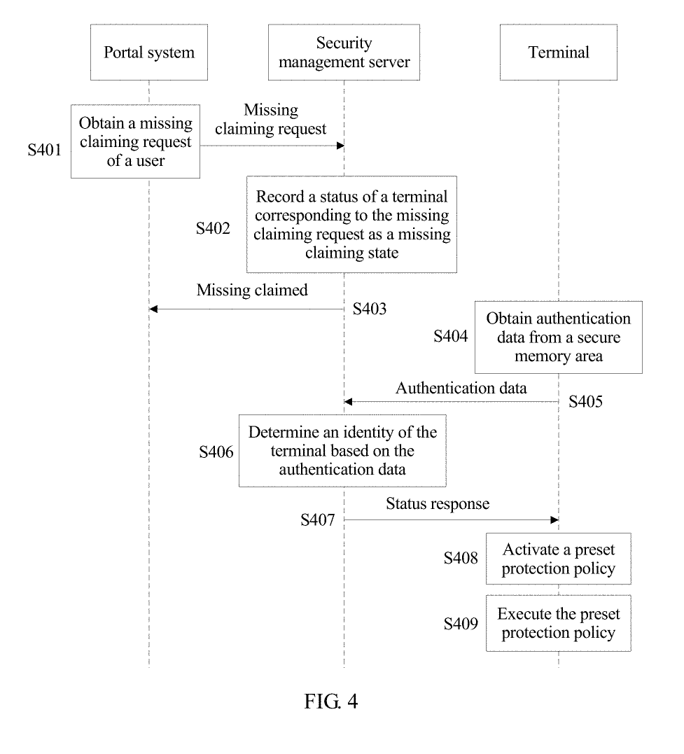

Referring to FIG. 4, FIG. 4 is a schematic flowchart of a method for ensuring terminal security according to a first embodiment of the present invention. As shown in the figure, the method in this embodiment of the present invention may include the following steps.

Step S401: A portal system Portal obtains a missing claiming request of a user, and sends the missing claiming request to a security management server PF Server.

Optionally, before sending the missing claiming request to the security management server PF Server, the portal system Portal needs to verify an identity of the user. After determining the identity of the user, the portal system Portal sends the missing claiming request to the security management server PF Server.

Specifically, the portal system Portal may verify the identity of the user by using an account system or by setting a preset rule (for example, setting a whitelist for accessing the portal system). For example, before receiving the missing claiming request of the user, the portal system obtains an account and a password that are entered by the user, determines the identity of the user when both the account and the password are correct, and then obtains the missing claiming request of the user. During specific implementation, the portal system may obtain the missing claiming request of the user by using a missing claiming button in the portal system.

Optionally, the missing claiming request may carry terminal identifier data, the terminal identifier data is used by the security management server PF Server to determine an identity of a terminal, and the security management server PF Server stores the terminal identifier data.

Specifically, the terminal identifier data may be data such as an IMEI, an IMSI, an MEID, or a universal unique identifier (Universal Unique Identifier, UUID) that is used to determine the identity of the terminal.

In a specific implementation, the portal system Portal may be a front-end interface of the security management server PF Server, and the security management server PF Server is a background management server of the portal system Portal. In this case, the portal system Portal may send the missing claiming request to the security management server by using a table plug-in (for example, a table). In another specific implementation, if a background management server of the portal system Portal is not the security management server PF Server, the portal system Portal first transmits the missing claiming request to the background management server of the portal system Portal, and the background management server sends the missing claiming request to the security management server PF Server.

Step S402: The security management server PF Server records a status of a terminal corresponding to the missing claiming request as a missing claiming state.

Specifically, the security management server PF Server records, in a same data table, the status of the terminal corresponding to the missing claiming request and the terminal identifier data.

For example, if the terminal identifier data is an IMEI, and an IMEI of the terminal corresponding to the missing claiming request is 123456789012345, data shown in Table 1 is added to a database of the security management server:

TABLE 1

| Key (primary key) | IMEI | State (state) |
|---|---|---|
| 1 | 123456789012345 | 0 |

Key is used to uniquely identify the record in the table, and that State is 0 indicates that the terminal whose IMEI is 123456789012345 is in the missing claiming state.

Step S403: The security management server PF Server sends a “missing claimed” response to the portal system Portal.

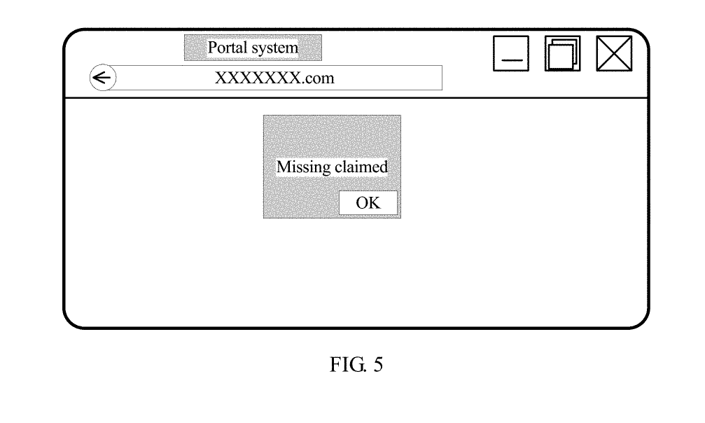

Specifically, the portal system Portal may display a missing claiming result to the user by using a pop-up window prompt or the like. As shown in FIG. 5, FIG. 5 is a schematic diagram of displaying a missing claiming result to a user by a portal system Portal according to an embodiment of the present invention. When receiving the “missing claimed” response sent by the security management server PF Server, the portal system Portal displays a pop-up window prompt “missing claiming succeeds” to the user.

In this case, after steps S101 to S103 are performed, the security management server PF Server stores the missing claiming state of the terminal, and waits for the terminal to perform status query when the terminal is powered on and connected to a network.

The following describes an interaction procedure between the terminal (namely, the terminal corresponding to the missing claiming request) and the security management server PF Server in steps S101 to S103.

Step S404: The terminal obtains authentication data from a secure memory area.

Specifically, the authentication data may be first authentication token data or first encrypted data.

Specifically, the secure memory area is set on a baseband chip 310, and the secure memory area may be corresponding to the secure memory area 3101 on the terminal shown in FIG. 3A.

Specifically, the secure memory area 3101 may store a security protection application program, the security protection application program may be a security protection client running on the baseband chip 310, and the terminal may obtain the authentication data from the secure memory area 3101 by using the security protection client.

Specifically, the security protection client may obtain the authentication data from the secure memory area of the baseband chip when the terminal is powered on and connected to the network.

Specifically, isolation and protection of the secure memory area may be implemented by using a “Trustzone” security technology.

Step S405: The terminal sends a status query request to the security management server PF Server, where the query request carries the authentication data.

Step S406: The security management server PF Server determines an identity of the terminal based on the authentication data.

Specifically, for example, if the authentication data carries the IMEI of the terminal, the security management server PF Server determines the identity of the terminal based on the IMEI, and queries, by using the IMEI, whether the database of the security management server PF Server includes a missing claiming record of the terminal.

Step S407: The security management server PF Server sends a status response to the terminal.

Specifically, the status response sent by the security management server

PF Server to the terminal includes two cases. In one case, the database of the security management server PF Server includes the missing claiming record of the terminal, and the status response is “missing claimed”. In the other case, the database of the security management server PF Server does not include the missing claiming record of the terminal, and the status response is “missing unclaimed”.

In this embodiment of the present invention, because the security management server records the missing claiming state of the terminal in step S402, the status response is “missing claimed”, and the status response received by the terminal is “missing claimed”. In this case, step S408 is performed.

Step S408: The terminal activates a preset protection policy.

Specifically, a flag bit Flag may be set as an activation parameter for activating the preset protection policy. If a value of the Flag is 0, the terminal keeps a current status. If a value of the Flag is 1, the terminal activates the preset protection policy. When determining that the status of the terminal is “missing claimed”, the value of the Flag is set to 1.

In this case, the preset protection policy of the terminal is enabled, and the terminal may execute the preset protection policy, in other words, the terminal performs step S409.

Step S409: The terminal executes the preset protection policy.

Specifically, the terminal indicates, in an alerting manner, that the terminal is currently in the missing claiming state, for example, the terminal displays an information prompt of “missing of the terminal has been claimed and the terminal cannot be operated currently” in a user interaction interface.

Optionally, the terminal may lock an application operating system (which is an operating system on an application processor herein) of the terminal, so that various application functions in the application operating system are in an unavailable state. Specifically, the terminal sends an AT instruction to the application operating system of the terminal by using the baseband chip, to instruct the application operating system to lock various application functions in the application operating system. For example, if applications such as an application A, an application B, and an application C run in the application operating system of the terminal, the operating system locks the application A, the application B, and the application C after receiving the AT instruction. The locked terminal can implement only a call function and an Internet access function.

Optionally, the terminal may collect various information of the terminal, and send the information to the security management server PF Server when the terminal is powered on and connected to the network. For example, the terminal may periodically obtain a location of the terminal, and send all obtained location information to the security management server PF Server when the terminal is powered on and connected to the network. For another example, when detecting that a telecommunication smartcard (for example, a subscriber identity module (Subscriber Identification Module, SIM) card, and a universal subscriber identity module (Universal Subscriber Identity Module, USIM) card) of the terminal is changed, the terminal may record information about the changed telecommunication smartcard, and send the information about the changed telecommunication smartcard to the security management server PF Server when the terminal is powered on and connected to the network.

Optionally, when the terminal is connected to the network, the terminal may obtain a remote control instruction of the security management server PF Server, execute a target operation corresponding to the remote control instruction, and return, to the security management server PF Server, an execution result of executing the target operation.

In the method shown in FIG. 4, when the terminal is connected to the network, after the terminal sends the status query request to the security management server PF Server and receives the status response sent by the security management server PF Server, the terminal activates the preset protection policy when the terminal determines, based on the status response, that the terminal is in the missing claiming state. Data (the authentication data and data related to the preset protection policy) that ensures terminal security is stored in the secure memory area of the baseband chip. Methods such as ROM flashing cannot invalidate the protection policy of the terminal, an antitheft function of the terminal can be normally implemented, and terminal security can be improved.

In a specific implementation, the terminal may perform, by using the security protection client running on the baseband chip, steps (steps S404 and S405 and steps S408 and S409) performed by the terminal in the embodiment corresponding to FIG. 4, and an application program corresponding to the security protection client is stored in the secure memory area. In this embodiment of the present invention, a specific implementation process of activating and performing the preset protection policy when the terminal and the security management server perform authentication by using an account system (to be specific, the authentication data is the first authentication token data) is different from a specific implementation process of activating and performing the preset protection policy when the terminal and the security management server perform authentication by using a key pair (to be specific, the authentication data is the first encrypted data). The following separately describes, by using a second embodiment to a fifth embodiment and by using the security protection client as an example, the implementation process of activating and performing the protection policy of the terminal when authentication is performed by using an account system and the implementation process of activating and performing the protection policy of the terminal when authentication is performed by using the key pair.

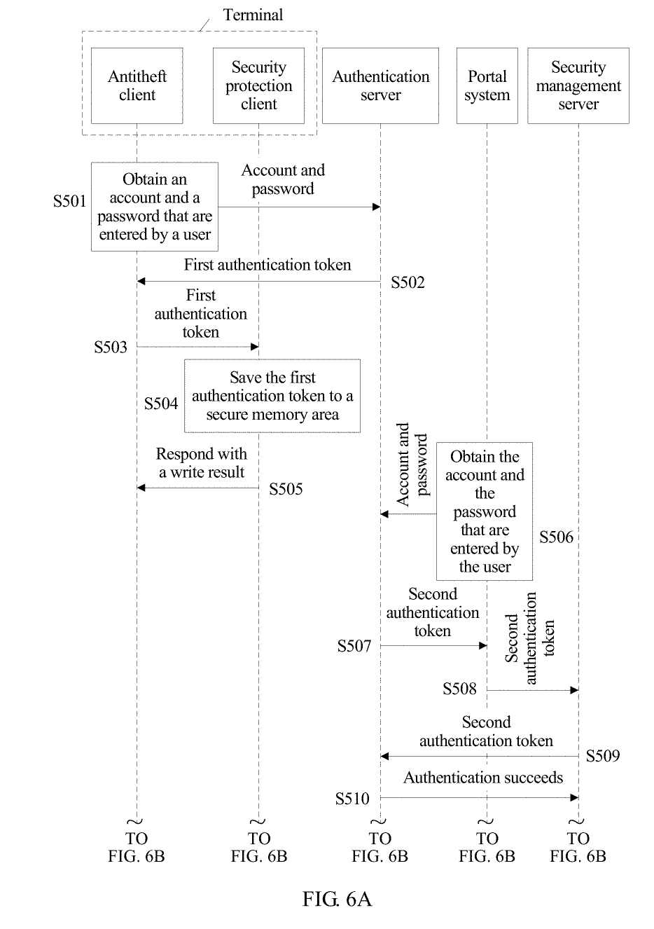

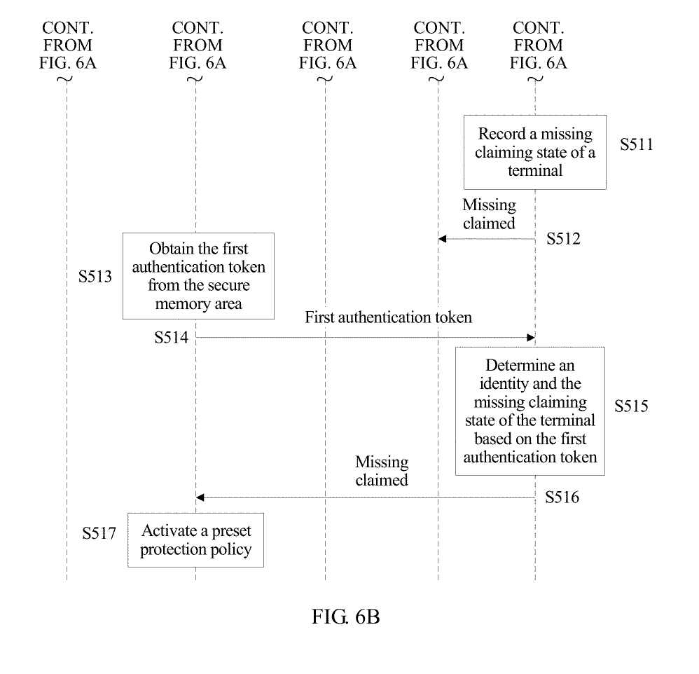

Referring to FIG. 6A and FIG. 6B, FIG. 6A and FIG. 6B are a schematic flowchart of a method for activating a preset protection policy according to a second embodiment of the present invention. As shown in the figure, the method includes the following steps.

Step S501: An antitheft client PF Client obtains an account and a password that are entered by a user, and sends the account and the password to an authentication server Up Server.

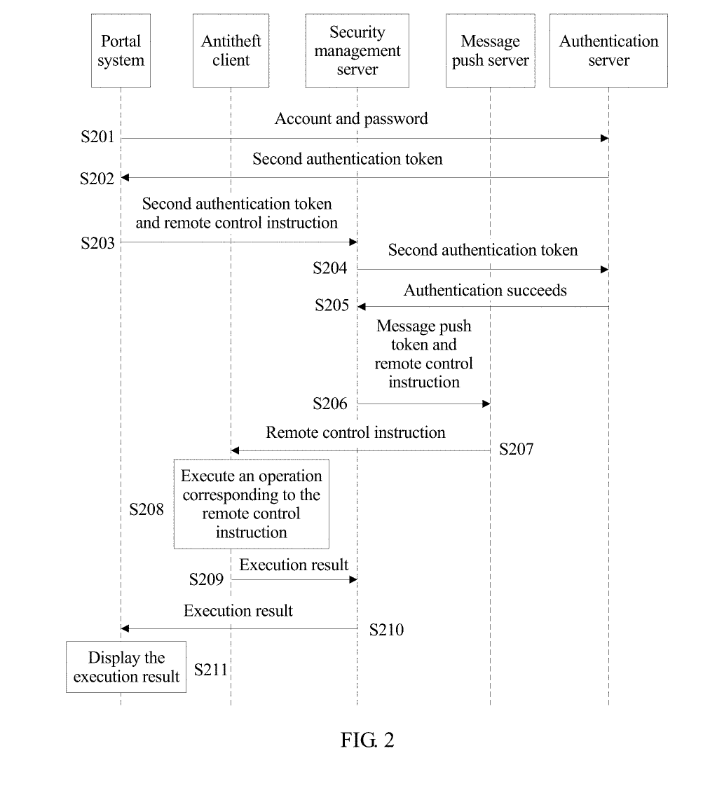

Specifically, the antitheft client PF Client, namely, the antitheft client in FIG. 1 or FIG. 2, runs in an application operating system of an application processor of a terminal, the antitheft client is one of the application programs in FIG. 3A, and an application program of the antitheft client is stored outside a secure memory area.

Specifically, the antitheft client PF Client obtains, by using a user interaction interface, the account and the password that are entered by the user. For example, the antitheft client PF Client invokes the user interface program in FIG. 3A to present a graphical operation interface to the user, and receives an operation of the user by using an input control such as a dialog or a key, to obtain the account and the password that are entered by the user.

It should be noted that before entering the account and the password on the antitheft client PF Client, the user further needs to register the account. A registration procedure is consistent with an account registration procedure in the prior art. Details are not described herein.

Step S502: When the account and the password are verified by the authentication server Up Server, the authentication server Up Server sends a first authentication token serviceToken to the antitheft client PF Client.

Specifically, the authentication server Up Server matches the account and the password with an account and a password that are stored in a database and that are set when the user performs registration. If the account is consistent with the account that is set by the user, and the password is consistent with the password that is set by the user, the authentication server Up Server determines that the account and the password are verified.

Specifically, the first authentication token serviceToken is a key between the terminal and the authentication server Up Server. When the terminal subsequently interacts with the authentication server Up Server, the authentication server Up Server may determine, based on the first authentication token serviceToken sent by the terminal, that a request of the terminal is a valid request.

Step S503: The antitheft client PF Client sends the first authentication token serviceToken to a security protection client.

Specifically, the antitheft client PF Client sends the first authentication token serviceToken to the security protection client by using an AT instruction.

It should be noted that in this embodiment of the present invention, the first authentication token serviceToken is corresponding to the authentication data in the first embodiment. In other words, the authentication data is the first authentication token serviceToken.

Step S504: The security protection client saves the first authentication token serviceToken to a secure memory area.

Step S505: The security protection client responds to the antitheft client PF Client with a write result.

In this case, the authentication data (namely, the first authentication token serviceToken) that is used to determine an identity of the terminal is stored in a secure memory area of a baseband chip. In a subsequent process, the security protection client may interact with a security management server PF Server by using the authentication data.

When the terminal is lost, the user logs in to a portal system Portal by using the account and the password, to claim missing of the terminal. The following describes a missing claiming procedure of the terminal by using steps S506 to S512.

Step S506: A portal system Portal obtains the account and the password that are entered by the user, and sends the account and the password to the authentication server Up Server.

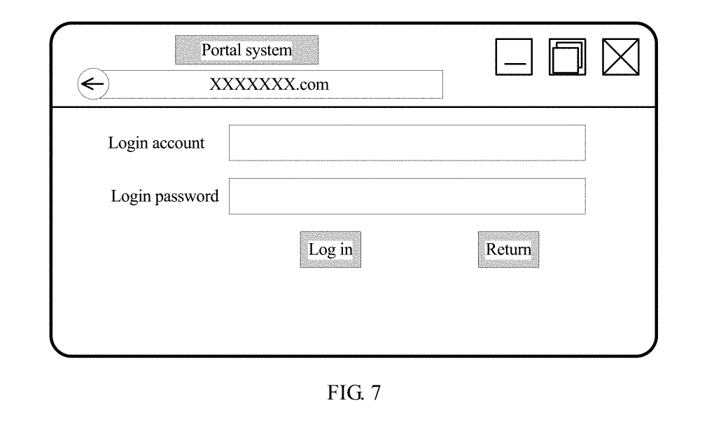

Specifically, the portal system Portal may obtain, by using a portal system page shown in FIG. 7, the account and the password that are entered by the user.

Step S507: When the account and the password are verified by the authentication server Up Server, the authentication server Up Server sends a second authentication token upToken to the portal system Portal.

Specifically, a manner of verifying the account and the password by the authentication server Up Server is described in step S502. Details are not described herein again.

Specifically, the second authentication token upToken is a key between the portal system Portal and the authentication server Up Server. When the portal system Portal subsequently interacts with the authentication server Up Server, the authentication server Up Server may determine, based on the second authentication token upToken sent by the portal system Portal, that a request of the portal system is a valid request.

Step S508: The portal system Portal obtains a missing claiming request of the user, and sends, to a security management server PF Server, the missing claiming request that carries the second authentication token upToken.

Specifically, the portal system Portal obtains the missing claiming request of the user by obtaining an operation performed by the user on the user interaction interface, for example, obtaining an operation of clicking a “missing claiming” button in the portal system by the user.

Specifically, a relationship between the portal system Portal and the security management server is described in step S401 in the first embodiment. Details are not described herein again.

Step S509: The security management server PF Server sends the second authentication token upToken to the authentication server Up Server, to determine validity of the missing claiming request.

Step S510: The authentication server Up Server sends an “authentication succeeds” response to the security management server PF Server.

Specifically, the second authentication token upToken is sent by the authentication server to the portal system Portal in step S507. When receiving the second authentication token upToken, the authentication server determines that the request of the portal system Portal is valid, in other words, the authentication succeeds.

Step S511: The security management server PF Server records a missing claiming state of a terminal.

Step S512: The security management server PF Server sends a “missing claimed” response to the Portal.

Specifically, specific implementations of steps S511 and S512 are described in steps S402 and S403 in the first embodiment. Details are not described herein again.

In this case, the security management server PF Server stores the missing claiming state of the terminal, and waits for the terminal to perform status query when the terminal is powered on and connected to a network.

Step S513: The security protection client obtains the first authentication token serviceToken from the secure memory area.

Step S514: The security protection client sends a status query request to the security management server PF Server, where the status query request carries the first authentication token serviceToken.

Optionally, the status query request further carries terminal identifier data of the terminal.

Step S515: The security management server PF Server determines an identity and the missing claiming state of the terminal based on the first authentication token serviceToken.

Specifically, the security management server PF Server sends the first authentication token serviceToken to the authentication server Up Server, and the authentication server Up Server performs authentication on the identity of the terminal. The first authentication token serviceToken is sent by the authentication server Up Server to the antitheft client PF Client of the terminal in step S502. When receiving the first authentication token serviceToken sent by the security protection client, the authentication server determines that the request of the terminal is valid, and the authentication server sends an “authentication succeeds” response to the security management server PF Server. Then the security management server PF Server determines the identity of the terminal.

Specifically, the security management server PF Server may determine the missing claiming state of the terminal based on the terminal identifier data of the terminal. For example, a database of the security management server PF Server stores the status record of the terminal shown in Table 1. If an IMEI of the terminal is 123456789012345, the security management server PF Server determines that the terminal is in the missing claiming state.

It should be noted that if the terminal described in step S515 is the terminal described in step S511, the terminal is in the “missing claiming” state, and the security management server PF Server performs step S516.

Step S516: The security management server PF Server sends a “missing claimed” status response to the security protection client.

Step S517: The security protection client activates a preset protection policy.

Specifically, for a specific execution manner of the preset protection policy, refer to step S409 in the first embodiment. Details are not described herein again.

Compared with enhancing security by performing an authentication activation procedure by using an account system in the prior art, in the method shown in FIG. 6A and FIG. 6B, the security protection client receives the first authentication token serviceToken sent by the antitheft client PF Client, and the first authentication token serviceToken is permanently stored in the secure memory area of the baseband chip. When the terminal is lost, the user may perform missing claiming in the portal system by using the account and the password. The security management server PF Server may store a missing claiming record of the terminal. The security protection client of the terminal may find the missing claiming state of the terminal by sending the serviceToken to the security management server PF Server, and activate the preset protection policy, to implement an antitheft function of the terminal. The antitheft function of the terminal is activated by the security protection client, and the serviceToken and an application program of the security protection client are stored in the secure memory area of the baseband chip. Even if the antitheft client PF Client is removed, the preset protection policy can also be activated. Therefore, terminal security is improved.

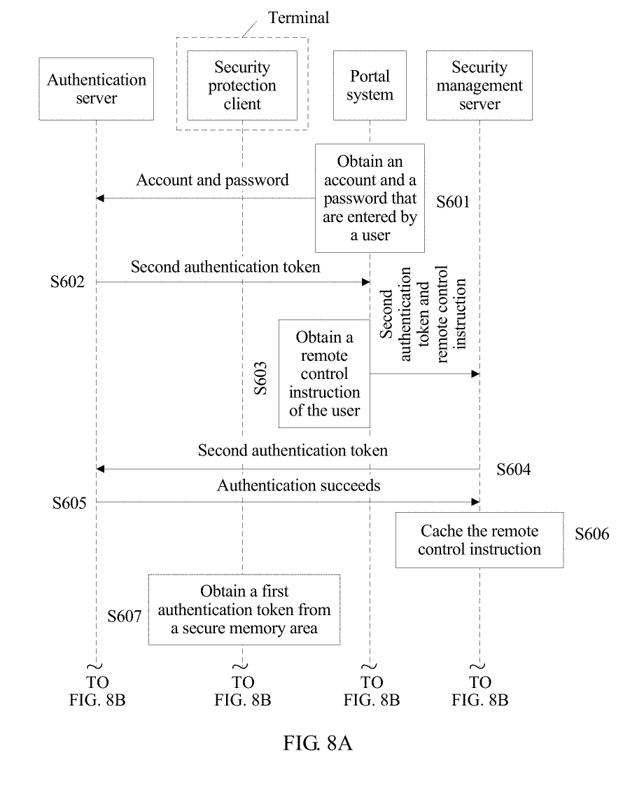

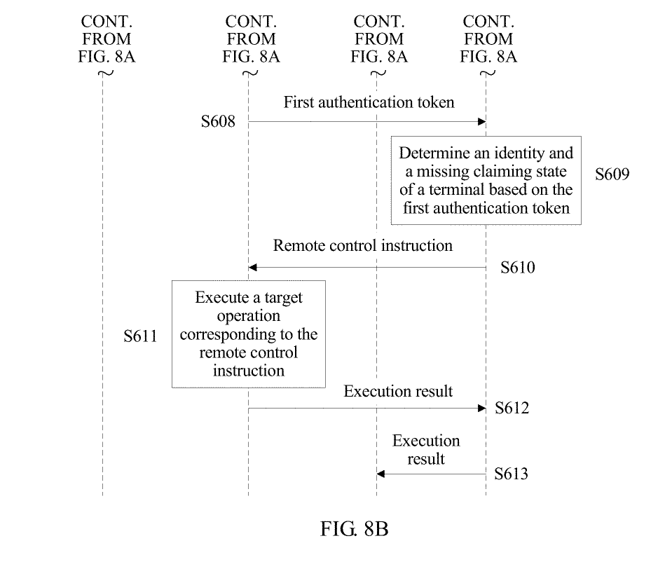

When the security protection client receives the “missing claimed” status response, the security protection client determines that the terminal is currently in the missing claiming state. After activating the preset protection policy, the security protection client executes the preset protection policy. In an implementation, the security protection client sends a control instruction query request to the security management server PF Server, to query whether there is a remote control instruction corresponding to the terminal in the security management server. Referring to FIG. 8A and FIG. 8B, FIG. 8A and FIG. 8B are a schematic flowchart of a method for executing a preset protection policy according to a third embodiment of the present invention. As shown in the figure, the method includes the following steps.

Step S601: A portal system Portal obtains an account and a password that are entered by a user, and sends the account and the password to an authentication server Up Server.

Step S602: When the account and the password are verified by the authentication server Up Server, the authentication server Up Server sends a second authentication token upToken to the portal system Portal.

Specifically, for specific implementations of steps S601 and S602, refer to descriptions in steps S506 and S507 in the second embodiment. Details are not described herein again.

Step S603: The portal system Portal obtains a remote control instruction of the user, and sends, to a security management server PF Server, a remote control request that carries the second authentication token upToken and the remote control instruction.

Specifically, the remote control instruction includes but is not limited to instructions used for controlling a terminal, such as a geographic location report instruction, a data erase instruction, and a contact report instruction.

Step S604: The security management server PF Server sends the second authentication token upToken to the authentication server Up Server, to determine validity of the remote control request.

Step S605: The authentication server Up Server sends an “authentication succeeds” response to the security management server PF Server.

Specifically, step S605 is the same as step S510 in the second embodiment. Details are not described herein again.

Step S606: The security management server PF Server caches the remote control instruction.

In this case, the security management server PF Server caches the remote control instruction. After activating a preset protection policy, a security protection client may obtain the remote control instruction when the terminal is powered on and connected to a network.

Step S607: A security protection client obtains a first authentication token serviceToken from a secure memory area.

Specifically, the first authentication token serviceToken is a key that is between the terminal and the server and that is generated after authentication is performed by using an account system. The first authentication token serviceToken is stored in a secure memory area of a baseband chip by the security protection client before the security protection client activates the preset protection policy (referring to step S504 in the second embodiment). The first authentication token serviceToken may be used to determine an identity of the terminal. When receiving the first authentication serviceToken, the security management server PF Server may determine that a request of the terminal is a valid request.

Step S608: The security protection client sends a control instruction query request to the security management server PF Server, where the control instruction query request carries the first authentication token serviceToken.

Step S609: The security management server PF Server determines an identity of a terminal based on the first authentication token serviceToken, and obtains the remote control instruction.

Specifically, after receiving the first authentication token serviceToken, the security management server PF Server sends the first authentication token serviceToken to the authentication server Up Server. The authentication server Up Server authenticates the identity of the terminal. When the authentication succeeds, the authentication server Up Server sends an “authentication succeeds” response to the security management server PF Server. The security management server PF Server determines the identity of the terminal, and then queries the remote control instruction corresponding to the terminal. The security management server PF Server caches the remote control instruction of the terminal in step S606.

Step S610: The security management server PF Server sends the remote control instruction to the security protection client.

Step S611: The security protection client executes a target operation corresponding to the remote control instruction.

Specifically, the security protection client may obtain a location of the terminal.

Specifically, the security protection client may erase data of the terminal, for example, contact information stored in the terminal, SMS message information stored in the terminal, picture information stored in the terminal, and account information of various applications that is stored in the terminal.

Specifically, the security protection client may enable various applications of the terminal to be in a disabled state.

Specifically, the security protection client may prompt, in a manner such as tweeting when the terminal is powered on, that the terminal is in a missing claiming state.

Step S612: The security protection client sends an execution result of executing the target operation to the security management server PF Server.

Specifically, for example, if the remote control instruction is to obtain a geographic location of the terminal, the security protection client sends the obtained geographic location of the terminal to the security management server PF Server. For another example, if the remote control instruction is to erase data of the terminal, the security protection client sends an “erasing succeeds” response to the security management server.

Step S613: The security management server PF Server sends the execution result to the Portal.

Specifically, when the execution result is status information (for example, geographic location information) related to the terminal, the security management server may further send the execution result to a server of the Public Security Bureau.

In the method shown in FIG. 8A and FIG. 8B, when connecting to the network, the security protection client actively queries whether there is the remote control instruction in the security management server PF Server. When there is the remote control instruction, the security protection client executes the target operation corresponding to the remote control instruction, and reports the execution result. The security protection client runs on the baseband chip, and the security protection client cannot be removed in a manner such as ROM flashing, thereby improving terminal security.

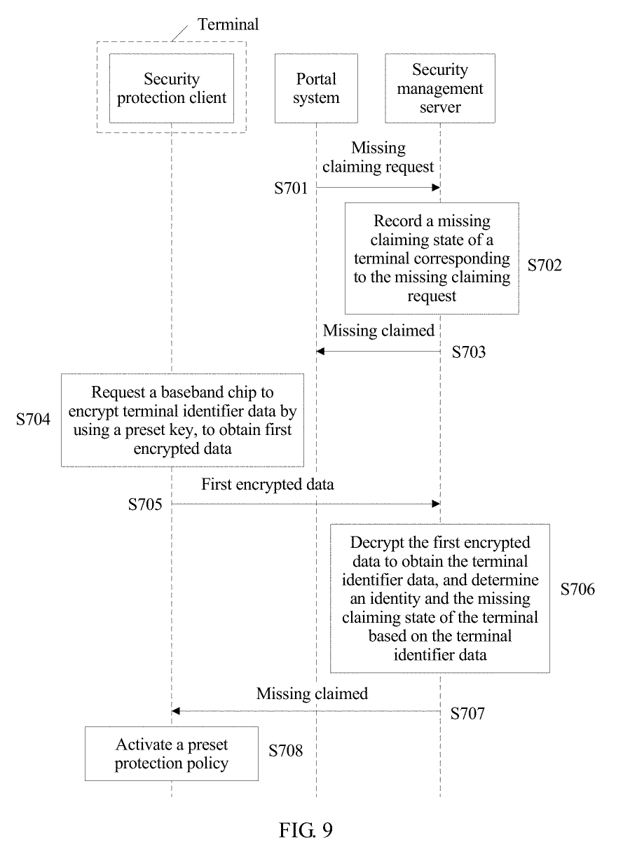

Referring to FIG. 9, FIG. 9 is a schematic flowchart of a method for activating a preset protection policy according to a fourth embodiment of the present invention. As shown in the figure, the method includes the following steps.

Step S701: A security management server PF Server obtains a missing claiming request of a user from a portal system Portal.

Specifically, the portal system obtains the missing claiming request of the user by receiving information sent by an administrator of the portal system.

For example, when a terminal is lost, the user provides the administrator of the portal system with a token of purchasing the terminal and terminal identifier data, and the administrator of the portal system opens the portal system Portal, and registers a missing claiming state of the terminal.

Specifically, the portal system may alternatively obtain the missing claiming request of the user by verifying an identity token provided by the user.

For example, the user opens the portal system, and uploads a picture of an invoice of purchasing the terminal and the terminal identifier data in the portal system. A background management server of the portal system identifies information on the invoice by using an optical character recognition (Optical Character Recognition, OCR) technology, to determine that the missing claiming request of the user is a valid request.

Step S702: The security management server PF Server records a missing claiming state of a terminal corresponding to the missing claiming request.

Step S703: The security management server PF Server sends a “missing claimed” response to the Portal.

Specifically, specific implementations of steps S702 and S703 are described in steps S402 and S403 in the first embodiment. Details are not described herein again.

In this case, the security management server PF Server stores the missing claiming state of the terminal, and waits for the terminal to query a status of the terminal when the terminal is powered on and connected to a network.

Step S704: A security protection client requests a baseband chip to encrypt terminal identifier data by using a preset key, to obtain first encrypted data.

Specifically, the preset key may be a public key, a private key, or a symmetric key.

Specifically, the preset key may be stored in a secure memory area of the baseband chip, or may be automatically generated by the baseband chip of the terminal.

Step S705: The security protection client sends the first encrypted data to the security management server PF Server.

Step S706: The security management server PF Server decrypts the first encrypted data to obtain the terminal identifier data, and determines, based on the terminal identifier data, an identity and the missing claiming state that are of the terminal.

Specifically, the security management server PF Server decrypts the first encrypted data by using a decryption key corresponding to the preset key.

For example, if the preset key is a public key, the decryption key is a private key corresponding to the public key. For another example, if the preset key is a private key, the decryption key is a public key corresponding to the private key.

Step S707: The security management server PF Server sends a “missing claimed” status response to the security protection client.

Step S708: The security protection client activates a preset protection policy.

Specifically, for a specific execution manner of the preset protection policy, refer to step S409 in the first embodiment. Details are not described herein again.

In the method shown in FIG. 9, authentication is not performed by using an account system in the prior art. Authentication is performed between the terminal and the security management server PF Server by using an agreed key pair. The security protection client and the security management server PF Server activate the preset protection policy by transmitting encrypted data. The security protection client runs on the baseband chip, and cannot be removed in a manner of ROM flashing, thereby improving terminal security. In addition, in this authentication method, the user does not need to register an account in advance, and the user only needs to claim missing when the terminal is lost. Therefore, user operations are reduced, and the method is simple and effective.

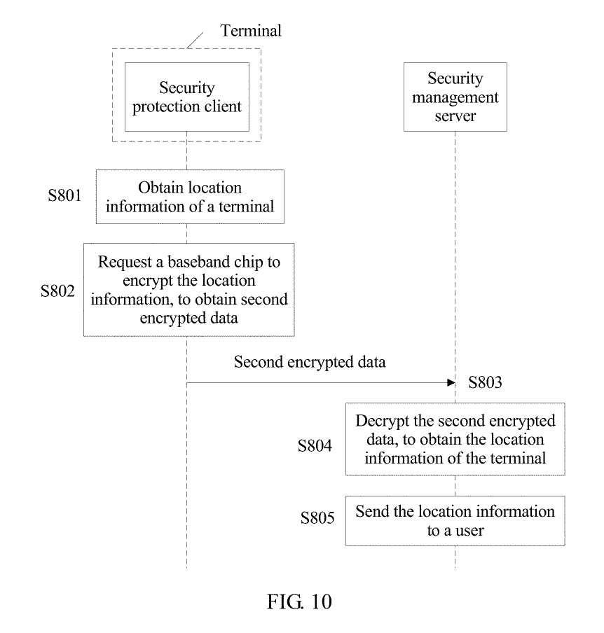

When the security protection client receives the “missing claimed” status response, the security protection client determines that the terminal is currently in the missing claiming state. After activating the preset protection policy, the security protection client executes the preset protection policy. In one implementation, the security protection client actively executes a security protection operation, and sends an execution result of executing the security protection operation to the security management server PF Server. Referring to FIG. 10, FIG. 10 is a schematic flowchart of a method for executing a preset protection policy according to a fifth embodiment of the present invention. As shown in the figure, the method includes the following steps.

Step S801: A security protection client obtains location information of a terminal.

Specifically, the security protection client obtains the location information of the terminal through GPS positioning when the terminal is powered on and connected to a network.

Step S802: The security protection client requests a baseband chip to encrypt the location information, to obtain second encrypted data.

Specifically, the baseband chip encrypts the location information by using the preset key mentioned in step S704 in the fourth embodiment.

Step S803: The security protection client sends the second encrypted data to a security management server PF Server.

Step S804: The security management server PF Server decrypts the second encrypted data, to obtain the location information of the terminal.

Specifically, the security management server PF Server decrypts the second encrypted data by using a decryption key corresponding to the preset key, to obtain the location information of the terminal.

Step S805: The security management server PF Server sends the location information to a user.

Specifically, the security management server PF Server may send the location information to a social account such as a mobile phone number or an email address reserved by the user.

Specifically, the security management server PF Server may alternatively send the location information to the portal system Portal mentioned in step S401 in the fourth embodiment.

In the method shown in FIG. 10, the security protection client obtains a geographic location of the terminal when the terminal is connected to the network, encrypts the geographic location, and sends the encrypted data to the security management server PF Server. After receiving the geographic location, the PF Server sends the geographic location to the user, so that the user can determine the location of the terminal. The security protection client runs on the baseband chip, and cannot be removed in a manner of ROM flashing, thereby improving terminal security.

It should be noted that, in addition to obtaining the location information of the terminal and reporting the location information to the security management server PF Server in the fifth embodiment, the security protection operation actively executed by the security protection client may further be executing the target operation corresponding to the remote control instruction in step S611 in the third embodiment. Details are not described herein.

It should be understood that the foregoing embodiment that is executed by the security protection client is only a specific implementation of the embodiments of the present invention. In an optional implementation, the terminal may further perform the foregoing method by using another application program or another function unit/module on the baseband chip, and the data that ensures terminal security is stored in the secure memory area.

For better understanding and implementing the foregoing solutions of the embodiments of the present invention, description is provided below with reference to specific application scenarios. For example, the terminal is a mobile phone. It is assumed that a user A is an owner of a mobile phone a, the mobile phone a has an antitheft function, and a security protection client of the mobile phone a runs on AMSS.

Case 1: A security protection client and a security management server PF Server perform authentication by using an account system.

The user A first registers a cloud service account (it is assumed that an account is XYY and a password is 123) of a manufacturer of the mobile phone a with the mobile phone or a portal system. When the user A wants to enable the antitheft function of the mobile phone a, the user A logs in to an antitheft client (for example, mobile phone retrieval) in an application operating system by using the account and the password. In this case, the antitheft client sends the account XYY and the password 123 to an authentication server of the manufacturer. When finding that there is an account whose account name is XYY and whose password is 123 in the account system, the authentication server determines that an identity of the user A is valid, and returns a first authentication token serviceToke (the serviceToken is a session token between the terminal and the authentication server, in other words, the serviceToken is an interaction key agreed on between the terminal and the authentication server, and when the terminal subsequently requests data from the authentication server, the terminal only needs to add the serviceToken and does not need to send the account and the password again) to the antitheft client.

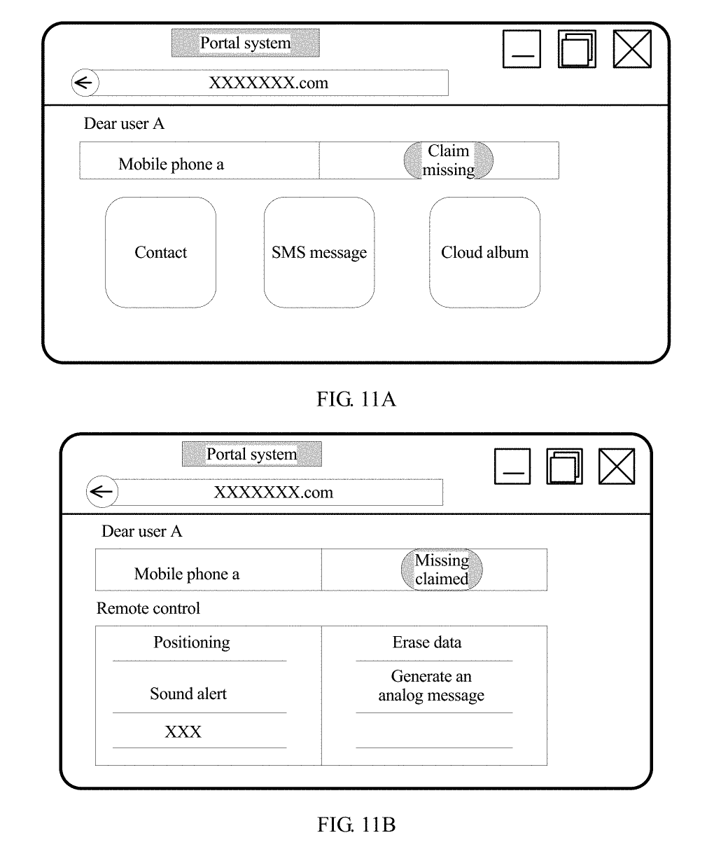

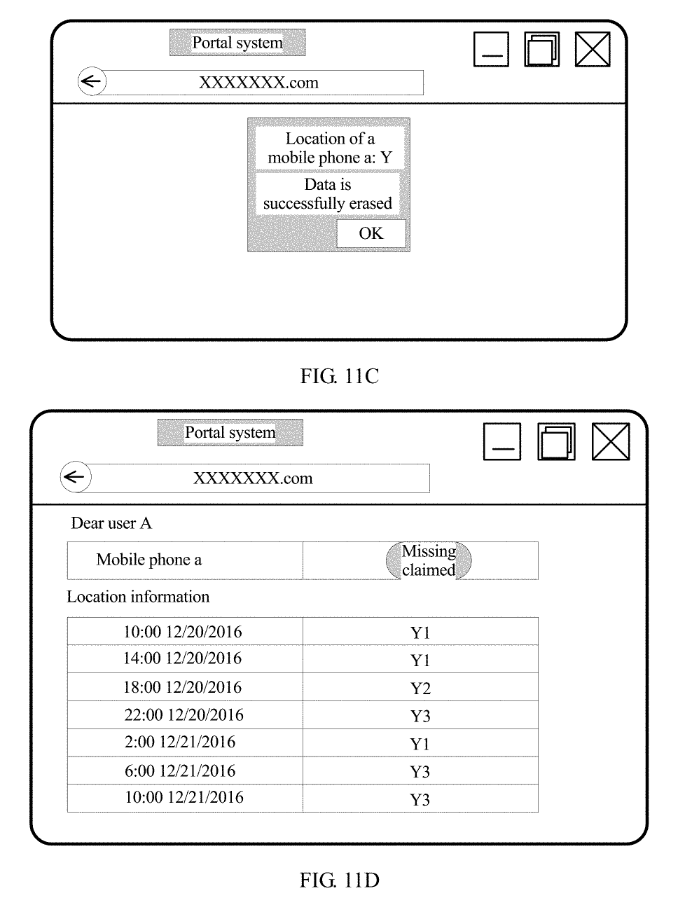

When the user A finds that the mobile phone a is lost, the user A enters a cloud service portal system of the manufacturer of the mobile phone a. The portal system may be shown in FIG. 7. The user A enters the account XYY and the password 123 in the portal system. The portal system transmits the account XYY and the password 123 to the authentication server. When finding that there is the account whose account name is XYY and whose password is 123 in the account system, the authentication server determines that the identity of the user A is valid, and returns a second authentication token upToken (the upToken is a session token between the portal system and the authentication server, in other words, the upToken is an interaction key agreed on between the portal system and the authentication server, and when the portal system subsequently interacts with the authentication server, the portal system only needs to add the upToken and does not need to send the account and the password again) to the portal system, to notify the portal system that the identity of the user A is valid. After the user A successfully logs in to the portal system, the portal system is shown in FIG. 11A. FIG. 11A is a schematic diagram of a page after a user successfully logs in to a portal system according to an embodiment of the present invention. The user A clicks a “missing claiming” button in the portal system. The portal system sends, to the security management server, a missing claiming request that carries the upToken. After sending the upToken to the authentication server and determining that the missing claiming request of the user A is valid, the security management server sends a “missing claimed” response to the portal system, and records a status of the mobile phone a as “missing claimed”. In this case, the portal system is shown in FIG. 5. After clicking an OK button, the user may enter a remote management page. Specifically, as shown in FIG. 11B, FIG. 11B is a schematic diagram of a remote management page of a portal system according to an embodiment of the present invention. The user A may select a remote control option in the portal system. If the user selects “positioning” and “erase data”, the portal system sends remote control instructions for the mobile phone a to the security management server, and the security management server caches the remote control instructions related to the mobile phone a.

When the mobile phone a is powered on and connected to a network, the security protection client initiates a status query request to the security management server. The request carries the serviceToken. After sending the serviceToken to the authentication server and determining that an identity of the mobile phone a is valid, the security management server queries the status of the mobile phone a, and sends a “missing claimed” status response to the security protection client. The security protection client enables a protection policy for the mobile phone a. The security protection client initiates a control instruction query request to the portal system. If the security management server finds that the remote control instructions related to the mobile phone a include a positioning instruction and a data erase instruction, the security management server sends the positioning instruction and the data erase instruction to the security protection client. The security protection client erases data in the mobile phone and obtains a geographic location of the mobile phone a. If the obtained geographic location is a location Y, the security protection client returns the location Y and an “erasing succeeds” response to the security management server. The security management server returns the location Y and the “erasing succeeds” response to the portal system. The portal system displays a remote control result to the user. Specifically, as shown in FIG. 11C, FIG. 11C is a schematic diagram of a page used by a portal system to display a remote control result to a user according to an embodiment of the present invention.

In another possible implementation, when the security protection client receives no remote control instruction of the user after enabling the antitheft function of the mobile phone a, the security protection client may periodically obtain the geographic location of the mobile phone a, and send the geographic location to the security management server. The security management server sends the geographic location to the portal system. After the user successfully logs in to the portal system, the user may find a geographic location movement track of the mobile phone a. Specifically, as shown in FIG. 11D, FIG. 11D is a schematic diagram of a page used by a portal system to display a geographic location movement track of a mobile phone to a user according to an embodiment of the present invention. In FIG. 11D, location information reported by the mobile phone a at different times is displayed on a web page of the portal system.

Case 2: An antitheft client PF Client and a security management server PF Server perform authentication by using a preset key.

When the mobile phone a is lost, the user A may provide a customer service staff of a manufacturer of the mobile phone a with an invoice of purchasing the mobile phone a and an IMEI serial number of the mobile phone a, and the customer service staff claims missing and performs remote control in a portal system. An interaction process of the portal system and the security management server is similar to that described in case 1. A difference lies in that no upToken is carried when the portal system sends a missing claiming request and a remote control instruction to the security management server, and the security management server considers the request as valid by default. A specific process is not described herein.

When the mobile phone a is powered on and connected to a network, a security protection client encrypts the IMEI serial number of the mobile phone a, and sends the encrypted IMEI serial number to the security management server. The security management server queries a status of the mobile phone a, and sends a “missing claimed” status response to the security protection client. The security protection client enables a protection policy for the mobile phone a. A procedure after the protection policy is enabled is similar to that described in case 1. Details are not described herein again.

The methods according to the embodiments of the present invention are described in detail above, and apparatuses according to the embodiments of the present invention are provided below.

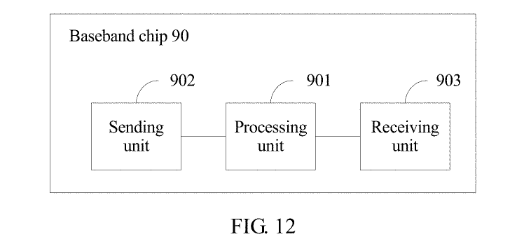

Referring to FIG. 12, FIG. 12 is a schematic structural diagram of a baseband chip according to an embodiment of the present invention. A secure memory area is set on the baseband chip 90, and the secure memory area is used to store data that ensures terminal security. The baseband chip includes a processing unit 901, a sending unit 902, and a receiving unit 903. Specific descriptions of the units are as follows.

The processing unit 901 is configured to obtain authentication data from the secure memory area.

The sending unit 902 is configured to send a status query request to a security management server. The status query request carries the authentication data, and the authentication data is used by the security management server to determine an identity of the terminal.

The receiving unit 903 is configured to receive a status response that is sent by the security management server based on the identity of the terminal.

The processing unit 901 is further configured to activate a preset protection policy when determining, based on the status response, that the terminal is in a missing claiming state.

It should be noted that for implementation of each unit, refer to corresponding descriptions of the method embodiment shown in FIG. 4, FIG. 6A and FIG. 6B, FIG. 8A and FIG. 8B, FIG. 9, or FIG. 10.

In the baseband chip 90 described in FIG. 12, the data that ensures terminal security is stored in the secure memory area of the baseband chip, and methods such as ROM flashing cannot invalidate the protection policy of the terminal, so that an antitheft function of the terminal can be normally implemented, and terminal security can be improved.

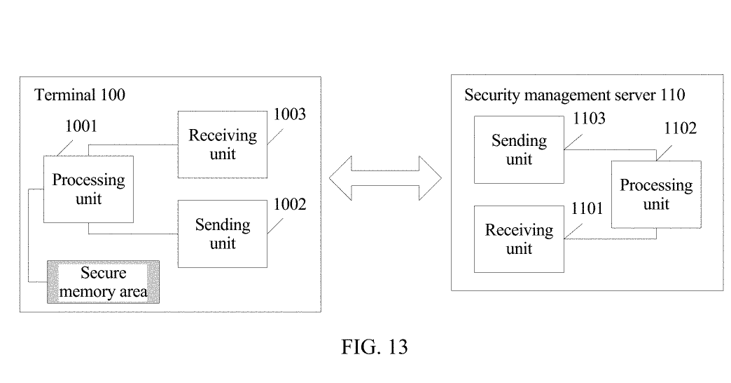

Referring to FIG. 13, FIG. 13 is a schematic structural diagram of a terminal and a security management server according to an embodiment of the present invention. As shown in FIG. 13, there is a communication connection such as a WiFi connection between a terminal 100 and a security management server 110, to implement data communication between the terminal 100 and the security management server 110. Function blocks of the terminal and the security management server may be implemented by using hardware, software, or a combination of hardware and software, to implement the solutions of the present invention. A person skilled in the art should understand that the function blocks described in FIG. 13 may be combined or separated into several sub-blocks to implement the solutions of the present invention. Therefore, the content described above in the present invention may support any possible combination or separation or further definition of the following function modules.

As shown in FIG. 13, a secure memory area is set on a baseband chip of the terminal, and the secure memory area is used to store data that ensures terminal security. The terminal 100 may include:

a processing unit 1001, configured to obtain authentication data from the secure memory area;

a sending unit 1002, configured to send a status query request to the security management server, where the status query request carries the authentication data, and the authentication data is used by the security management server to determine an identity of the terminal; and

a receiving unit 1003, configured to receive a status response that is sent by the security management server based on the identity of the terminal.

The processing unit 1001 is further configured to activate a preset protection policy when determining, based on the status response, that the terminal is in a missing claiming state.

As shown in FIG. 13, the security management server 110 may include:

a receiving unit 1101, configured to receive a status query request sent by the terminal, where the status query request carries authentication data, and the authentication data is stored in a secure memory area of a baseband chip of the terminal;

a processing unit 1102, configured to determine an identity of the terminal based on the authentication data; and

a sending unit 1103, configured to send a status response to the terminal, where the status response is used by the terminal to determine a status of the terminal, and the terminal activates a preset protection policy when determining that the terminal is in a missing claiming state.

In the terminal 100 described in FIG. 13, the data that ensures terminal security is stored in the secure memory area of the baseband chip, and methods such as ROM flashing cannot invalidate the protection policy of the terminal, so that an antitheft function of the terminal can be normally implemented, and terminal security can be improved.

It should be noted that for content that is not mentioned in the embodiment corresponding to FIG. 13 and specific implementation of each function unit, refer to the embodiment of FIG. 4, FIG. 6A and FIG. 6B, FIG. 8A and FIG. 8B, FIG. 9, or FIG. 10. Details are not described herein again.

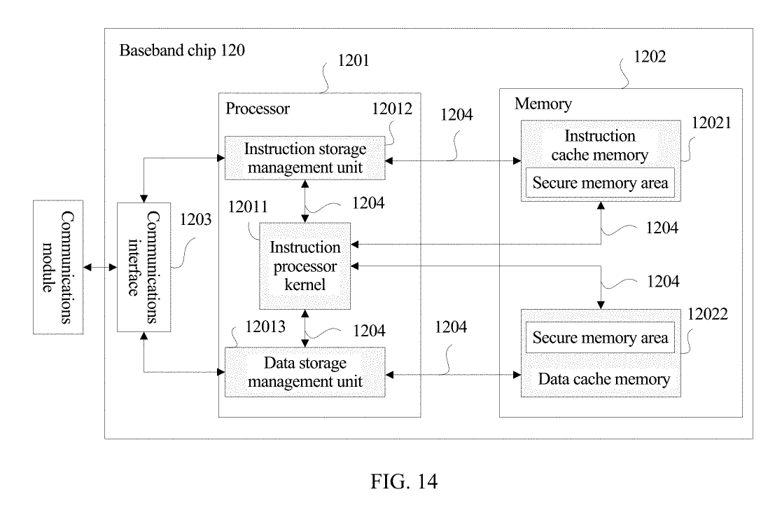

Referring to FIG. 14, FIG. 14 is a schematic structural diagram of another baseband chip according to an embodiment of the present invention. The baseband chip 120 includes a processor 1201, a memory 1202, and a communications interface 1203. The processor 1201, the memory 1202, and the communications interface 1203 are connected by using one or more communications buses 1204.

The communications interface 1203 is connected to a communications module outside the baseband chip.

The memory 1202 includes an instruction cache memory 12021 and a data cache memory 12022. The instruction cache memory 12021 is configured to store a program instruction. The data cache memory 12022 is configured to store data. The instruction cache memory and the data cache memory each include a secure memory area.

During specific implementation, the memory 1202 includes but is not limited to a random access memory (English: random access memory, RAM for short), a read-only memory (English: read-only memory, ROM for short), an erasable programmable read only memory (English: erasable programmable read only memory, EPROM for short), or a compact disc read-only memory (English: compact disc read-only memory, CD-ROM for short).

The processor 1201 includes an instruction processor kernel 12011, an instruction storage management unit 12012, and a data storage management unit 12013. The instruction storage management unit 12012 is configured to manage a program instruction stored in the instruction cache memory 12021. The data storage management unit 12013 is configured to manage data stored in the data cache memory 12022. The processor kernel 12011 may cooperate with the storage management unit 12012 and the data storage management unit 12013 to perform the following operations:

obtaining authentication data from a secure memory area;

sending a status query request to a security management server, where the status query request carries the authentication data, and the authentication data is used by the security management server to determine an identity of a terminal;

receiving a status response that is sent by the security management server based on the identity of the terminal; and

activating a preset protection policy when determining, based on the status response, that the terminal is in a missing claiming state.

During specific implementation, the processor kernel 12011 invokes, by using the instruction storage management unit 12012, an application program stored in the secure memory area of the instruction cache memory 12021. The processor kernel 12011 executes a corresponding operation based on the application program: First, the processor kernel 12011 instructs the data storage management unit 12023 to obtain the authentication data from the secure memory area of the data cache memory 12022; then, the processor kernel 12011 sends the authentication data to the security management server by using the communications interface 1203; afterwards, the processor kernel 12011 receives, by using the communications interface 1203, the status response sent by the security management server; and finally, the processor kernel 12011 activates the preset protection policy when determining, based on the status response, that the terminal is in the missing claiming state.

In the foregoing process, the processor kernel 12011 may communicate with the security management server (sending the status query request or receiving the status response) by using the communications module (for example, a radio frequency module) of the terminal outside the baseband chip.

It should be noted that the processor kernel 12011 may further cooperate with the instruction storage management unit 12012 and the data storage management unit 12013 to execute operations executed by the security protection client in the method shown in FIG. 6A and FIG. 6B, FIG. 8A and FIG. 8B, FIG. 9, or FIG. 10.

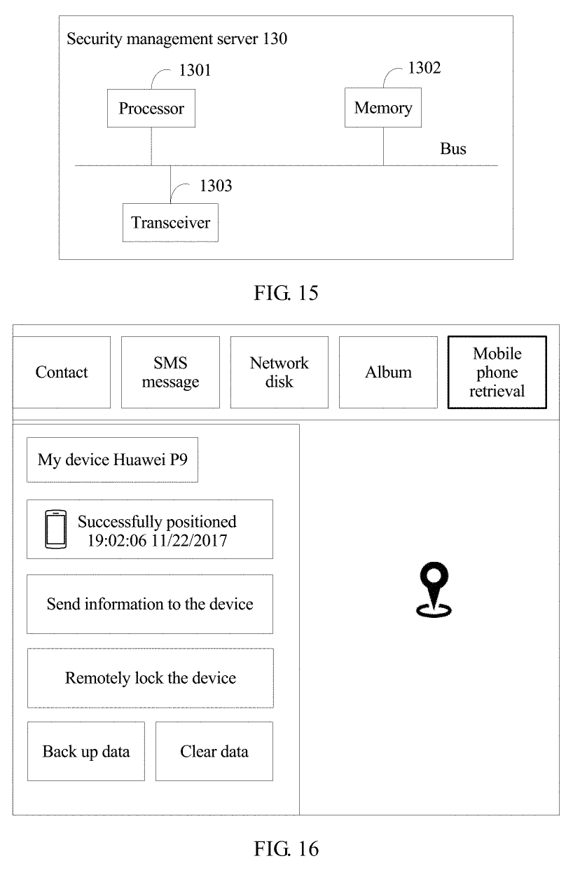

Referring to FIG. 15, FIG. 15 is a schematic structural diagram of another security management server according to an embodiment of the present invention. The security management server 130 may include a processor 1301, a memory 1302, and a transceiver 1303. The processor 1301, the memory 1302, and the transceiver 1303 are connected to each other by using a bus.

The memory 1302 includes but is not limited to a random access memory

(English: random access memory, RAM for short), a read-only memory (English: read-only memory, ROM for short), an erasable programmable read only memory (English: erasable programmable read only memory, EPROM for short), or a compact disc read-only memory (English: compact disc read-only memory, CD-ROM for short). The memory 1302 is configured to store related instructions and data. The transceiver 1303 is configured to receive and send data.

The processor 1301 may be one or more central processing units (English: Central Processing Unit, CPU for short). When the processor 1301 is one CPU, the CPU may be a single-core CPU, or may be a multi-core CPU.

The processor 1301 in the security management server 130 is configured to read program code stored in the memory 1302, and perform the following operations:

receiving, by using the transceiver 1303, a status query request sent by a terminal, where the status query request carries authentication data, and the authentication data is stored in a secure memory area of a baseband chip of the terminal;

determining an identity of the terminal based on the authentication data; and

sending a status response to the terminal by using the transceiver 1303, where the status response is used by the terminal to determine a status of the terminal, and the terminal activates a preset protection policy when determining that the terminal is in a missing claiming state.

It should be noted that the processor 1301 may further execute operations executed by the security management server in the method shown in FIG. 4, FIG. 6A and FIG. 6B, FIG. 8A and FIG. 8B, FIG. 9, or FIG. 10.

An embodiment of the present invention provides a method for ensuring terminal (for example, a mobile phone) security, to resolve a problem that an antitheft function of a terminal fails when an operating system on an application processor of the terminal is removed or replaced. When the terminal device shown in FIG. 3A to FIG. 3D is used, user security information may be stored in a secure memory area of a baseband chip, or an antitheft module may run in a TEE trusted execution environment and security information may be stored in a hardware security resource. The security information may be an account, a password, and various application programs and data. In some embodiments, the security information may be used to establish a connection to a server, so as to perform data transmission.

In some embodiments, a user may log in to a server or a portal system by using a cloud account and the like. In some embodiments, the server may be provided by a mobile phone manufacturer. In some embodiments, the user may alternatively send a mobile phone remote control instruction to the server. The remote control instruction may be one or more of deleting data, GPS positioning, data backup, remote locking, and sending a message.

FIG. 16 shows a remote control instruction interface according to a possible embodiment. For example, the interface may be provided by a terminal device that has a display. In some embodiments, the interface includes but is not limited to the following controls: “send information to the device”, “remotely lock the device”, “back up data”, and “clear data”. In some embodiments, a user may further view data that is synchronized from a mobile phone to a server, such as contact information, an SMS message, a network disk, and an album. In some embodiments, the interface may further provide a map service, to view a current location of the mobile phone.

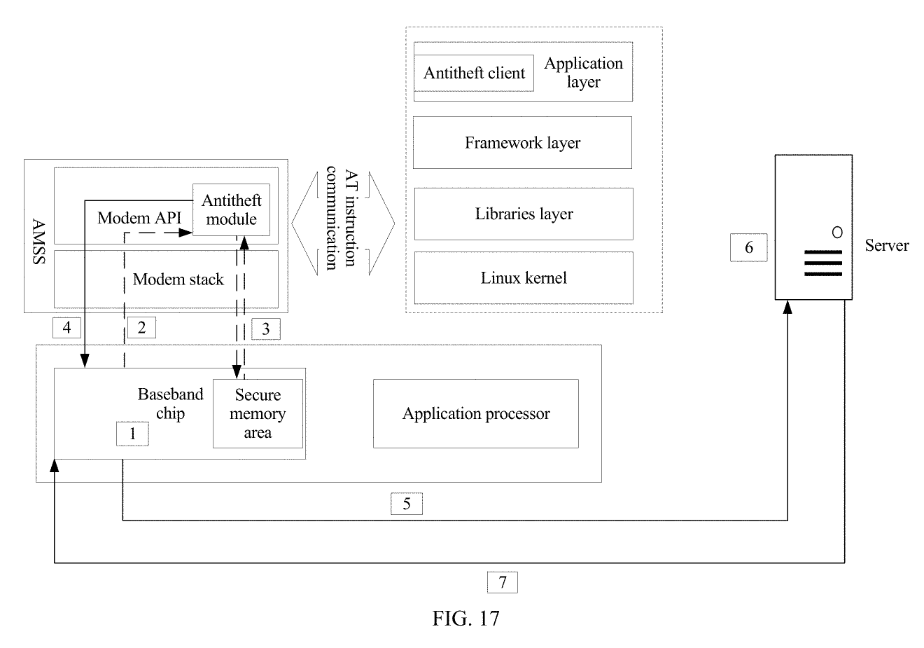

In some embodiments, the user logs in to the interface shown in FIG. 16, and sends a remote control instruction. For example, the user may click a “data backup” button. As shown in FIG. 17, a method for ensuring security of a mobile phone is provided, and a running procedure is as follows:

Step 1: A baseband chip of the mobile phone detects whether the mobile phone is connected to a network.

Step 2: When detecting that the mobile phone is connected to the network, the baseband chip reports a request to an antitheft module in an AMSS system.

Step 3: After receiving the request of the baseband chip, the antitheft module reads user security information in a secure memory area of the baseband chip.

Step 4: After reading the user security information in the secure memory area of the baseband chip, the antitheft module sends an instruction to a server by using the baseband chip, where the instruction includes the user security information.

Step 5: The server performs authentication on the received user information, and after the authentication succeeds, the mobile phone may receive an instruction sent by the server.

Step 6: The server sends the instruction to the mobile phone, where the instruction includes operations such as deleting data, positioning, remote locking, data backup, sending an SMS message, and alerting. The instruction is a mobile phone remote control instruction sent by a user. It should be noted that when the mobile phone does not access the server, the server may receive a remote control instruction. In this case, the server stores the remote control instruction, and sends the remote control instruction to the mobile phone when the mobile phone accesses the server.

It should be noted that, in step 1, a triggering condition of reporting the request to the antitheft module in the AMSS system by the baseband chip may be that the baseband chip detects that the mobile phone is connected to the network. For example, the baseband chip may detect whether the mobile phone is connected to various signals such as WiFi, 2G/3G/4G Bluetooth, GPRS, and ZigBee. In some embodiments, the mobile phone may periodically send the user security information to the server, for example, the mobile phone may send the user security information to the server every 5 minutes. In some embodiments, the mobile phone may send the user security information to the server at a fixed time, for example, the mobile phone may send the user security information to the server at 8 o'clock every morning. In some embodiments, a triggering condition of reporting the request to the antitheft module in the AMSS system by the baseband chip may be detecting that the mobile phone is synchronizing data to the server, for example, the mobile phone synchronizes an album to the server. In some embodiments, the baseband chip may periodically detect whether the mobile phone is synchronizing data to the server or the baseband chip may detect, at a fixed time, whether the mobile phone is synchronizing data to the server, for example, the baseband chip may detect, at 8 o'clock every day or every 5 minutes, whether the mobile phone is synchronizing data to the server. In some embodiments, a triggering condition of reporting the request to the antitheft module in the AMSS system by the baseband chip may be that the mobile phone is running an application program, for example, the mobile phone opens a camera application program. In some embodiments, a triggering condition of reporting the request to the antitheft module in the AMSS system by the baseband chip may be that the mobile phone receives some operations related to user security, for example, the operations may be entering an incorrect password, exiting a cloud account of the mobile phone, deleting data, and powering on or powering off

In step 3, the baseband chip may also upload the security information to the antitheft module.

In step 5, the baseband chip establishes a data connection to the server by sending the user security information. In some embodiments, the mobile phone may access the server or perform data transmission by using cloud account information in the security information.

In some embodiments, after receiving the remote control instruction sent by the server, the mobile phone may perform operations such as deleting data, positioning, remote locking, data backup, sending an SMS message, and alerting.

The method for ensuring security of a mobile phone provided in this embodiment is applicable to a scenario in which the mobile phone is lost, and in particular, to a scenario in which the mobile phone is logged out, the cloud account is deleted, a mobile phone system is reset or ROM flashed, the mobile phone is disconnected from the network, and the like. In this embodiment, the user security information is stored in the secure memory area of the baseband chip, or the antitheft module runs in a TEE trusted execution environment and the security information is stored in a hardware security resource. Therefore, even when the mobile phone system is reset, the mobile phone can receive the remote control instruction from the server, so as to ensure security of the mobile phone.

It should be noted that in some embodiments, the mobile phone may also automatically report information such as positioning information to the server. In some embodiments, the mobile phone may periodically and automatically report the positioning information or automatically report the positioning information at a fixed time, for example, the mobile phone may automatically report the positioning information at 8 o'clock every day or every 5 minutes. In some embodiments, a condition of automatically reporting the information by the mobile phone may be low power, for example, power is lower than 10%.

In conclusion, by implementing the embodiments of the present invention, data that ensures terminal security is stored in a secure memory area of a baseband chip, and the data cannot be deleted in a manner such as ROM flashing, so that an antitheft function of the terminal can be normally implemented, and terminal security can be improved.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium includes: any medium that can store program code, such as a ROM, a random access memory RAM, a magnetic disk, or an optical disc.

1. A method, performed by a baseband chip of a terminal to ensure a terminal security, comprising:
obtaining authentication data from a secure memory area, the secure memory area being set on the baseband chip of the terminal and configured to story data to ensure the terminal security;
sending a status query request to a security management server, the status query request carrying the authentication data, and the authentication data being used by the security management server to determine an identity of the terminal;
receiving a status response from the security management server based on the identity of the terminal; and
activating, based on the status response, a preset protection policy when the terminal is in a missing claiming state.

2. The method of claim 1, wherein the authentication data comprises first authentication token data, and before obtaining the authentication data from the secure memory area, the method further comprising:
receiving the first authentication token data from an application processor of the terminal; and
saving the first authentication token data to the secure memory area.

3. The method of claim 1, wherein the authentication data comprises first encrypted data, and before obtaining the authentication data from the secure memory area, the method further comprising:
encrypting terminal identifier data using a preset key to obtain the first encrypted data; and
saving the first encrypted data to the secure memory area.

4. The method of claim 1, wherein the preset protection policy comprises:
sending a control instruction query request carrying the authentication data to the security management server;
receiving a remote control instruction from the security management server;
executing a target operation corresponding to the remote control instruction; and
returning, to the security management server, an execution result obtained after the target operation is executed.

5. The method of claim 1, wherein the preset protection policy comprises:
obtaining current location information of the terminal;
encrypting the current location information of the terminal to obtain second encrypted data; and
sending the second encrypted data to the security management server.

6. The method of claim 1, wherein the preset protection policy comprises prompting, in an alerting manner, that the terminal is in the missing claiming state.

7. A method, performed by a terminal to ensure a terminal security, comprising:
obtaining authentication data from a secure memory area, the secure memory area being set on a baseband chip of the terminal and configured to store data to ensure the terminal security;
sending a status query request carrying the authentication data to a security management server, the authentication data being used by the security management server to determine an identity of the terminal;
receiving a status response from the security management server based on the identity of the terminal; and
activating, based on the status response, a preset protection policy when the terminal is in a missing claiming state.

8. The method of claim 7, wherein the authentication data comprises first authentication token data, and before obtaining the authentication data from the secure memory area, the method further comprising:
receiving the first authentication token data from an authentication server after identity verification information of a user of the terminal that is received from the terminal is verified by the authentication server; and
saving the first authentication token data to the secure memory area.

9. The method of claim 7, wherein the authentication data comprises first encrypted data, and before obtaining the authentication data from the secure memory area, the method further comprising requesting the baseband chip to encrypt terminal identifier data using a preset key to obtain the first encrypted data.

10. The method of claim 7, wherein the preset protection policy comprises:
sending a control instruction query request carrying the authentication data to the security management server;
receiving a remote control instruction from the security management server;
executing a target operation corresponding to the remote control instruction; and
returning, to the security management server, an execution result obtained after the target operation is executed.

11. The method of claim 7, wherein the preset protection policy comprises:
obtaining current location information of the terminal;
requesting the baseband chip to encrypt the current location information to obtain second encrypted data; and
sending the second encrypted data to the security management server.

12. The method of claim 7, wherein the preset protection policy comprises prompting, in an alerting manner, that the terminal is in the missing claiming state.

13.-18. (canceled)

19. A baseband chip, comprising:
a secure memory area set on the baseband chip and configured to store data to ensure a terminal security;
a processor coupled to the secure memory area and configured to obtain authentication data from the secure memory area;
a transmitter coupled to the secure memory area and the processor and configured to send a status query request to a security management server, the status query request carrying the authentication data, and the authentication data being used by the security management server to determine an identity of the terminal; and
a receiver coupled to the secure memory area, the processor and the transmitter and configured to receive a status response from the security management server based on the identity of the terminal, and
the processor being further configured to activate, based on the status response, a preset protection policy when the terminal is in a missing claiming state.

20. The baseband chip of claim 19, wherein the authentication data comprises first authentication token data, the receiver being further configured to receive the first authentication token data from an application processor of the terminal, and the processor being further configured to save the first authentication token data to the secure memory area.

21. The baseband chip of claim 19, wherein the authentication data comprises first encrypted data, and the processor being further configured to:
encrypt terminal identifier data using a preset key to obtain the first encrypted data; and
store the first encrypted data into the secure memory area.

22. The baseband chip of claim 19, wherein the transmitter is further configured to send a control instruction query request carrying the authentication data to the security management server, the receiver being further configured to receive a remote control instruction from the security management server, and the processor being further configured to:
execute a target operation corresponding to the remote control instruction; and
return, to the security management server, an execution result obtained after the target operation is executed.

23. The baseband chip of claim 19, wherein the processor being further configured to:
obtain current location information of the terminal; and
encrypt the current location information of the terminal to obtain second encrypted data, and
the transmitter being further configured to send the second encrypted data to the security management server.

24. The baseband chip of claim 19, wherein the processor being further configured to prompt, in an alerting manner, that the terminal is in the missing claiming state.

25. A terminal, comprising:
a secure memory area set on a baseband chip of the terminal and configured to store data to ensure a terminal security;
a processor coupled to the secure memory area and configured to obtain authentication data from the secure memory area;
a transmitter coupled to the secure memory area and the processor and configured to send a status query request to a security management server, the status query request carrying the authentication data, and the authentication data being used by the security management server to determine an identity of the terminal; and
a receiver coupled to the secure memory area, the processor and the transmitter and configured to receive a status response from the security management server based on the identity of the terminal, and
the processor being further configured to activate, based on the status response, a preset protection policy when the terminal is in a missing claiming state.

26. The terminal of claim 25, wherein the authentication data comprises first authentication token data, the receiver being further configured to receive the first authentication token data from an authentication server after identity verification information of a user of the terminal that is received from the terminal is verified by the authentication server, and the processor being further configured to save the first authentication token data to the secure memory area.

27.-36. (canceled)
